(19) United States
(12) Patent Application Publication
(10) Pub. No.: US 2015/0347833 A1
(43) Pub. Date: Dec. 3, 2015

(54) Noncontact Biometrics with Small Footprint

(71) Applicants: Mark Ries Robinson, Albuquerque, NM (US); Craig Lawrence Hatch, Albuquerque, NM (US); Victor Gerald Grafe, Corrales, NM (US)

(72) Inventors: Mark Ries Robinson, Albuquerque, NM (US); Craig Lawrence Hatch, Albuquerque, NM (US); Victor Gerald Grafe, Corrales, NM (US)

(21) Appl. No.: 14/730,218

(22) Filed: Jun. 3, 2015

Related U.S. Application Data
(60) Provisional application No. 62/007,294, filed on Jun. 3, 2014.

(51) Int. Cl. G06K 9/00; H04N 5/372; G06T 17/20; G06K 9/22; H04N 13/02; H04N 9/31

(52) U.S. Cl. CPC G06K 9/00375; H04N 13/0275; H04N 9/31; G06T 17/20; G06K 9/00536; G06K 9/00906; G06K 9/22; H04N 5/372; G06K 2009/00395

(57) ABSTRACT

The present invention provides methods and apparatuses that can provide three dimensional measurements of objects, without contact and with advantages not present in the art. Embodiments of the invention can be used to provide noncontact biometrics, in small footprints.

### CROSS-REFERENCE TO RELATED APPLICATIONS

This application claims priority to U.S. provisional 62/007294, filed Jun. 3, 2014, which is incorporated herein by reference.

### TECHNICAL FIELD

This invention relates to the field of identification of individuals using biometrics.

### BACKGROUND ART

This application relates to biometric systems that creates a small footprint when compared with conventional noncontact biometrics. The system is especially suited for applications where physical space is limited such as cellular phones, tablets and laptops.

“Biometrics” refers generally to the statistical analysis of characteristics of living bodies. One category of biometrics includes “biometric identification,” which commonly operates under one of two modes to provide automatic identification of people or to verify purported identities of people. Biometric sensing technologies measure the physical features or behavioral characteristics of a person and compare those features to similar prerecorded measurements to determine whether there is a match. Physical features that are commonly used for biometric identification include faces, irises, hand geometry, vein structure, and fingerprint patterns, which is the most prevalent of all biometric-identification features. Current methods for analyzing collected fingerprints include optical, capacitive, radio-frequency, thermal, ultrasonic, and several other less common techniques.

The value of biometrics continues to increase with more information stored on the web, electronic data and money transfers, and the use of mobile devices. In most cases the user wants a biometric device that is very small in terms of physical footprint but maintains high performance. Mobile phones represent such a situation. Although biometric systems have been embedded in smart phones, the overall performance of the fingerprint sensors has been quite limited due to the physical size of the platen. Due to size limitations, the systems acquire only a portion of the fingerprint. Swipe sensors can increase the information content obtained but are unlikely to result in a high performance system.

Most existing fingerprint sensors, palm prints and hand geometry systems require contact between the individual and the biometric system. Fingerprints rely on relatively high-quality contact between the finger and the sensor to obtain images. Obtaining adequate contact is both finicky and time-consuming because of factors related to individual characteristics of users of the sensors, the quality of the skin, and environmental variability. For some individuals and under some circumstances, achieving adequate contact is impossible. Difficulty of consistent fingerprint capture limits the effectiveness and scope of applications that utilize fingerprint biometrics for identity management. Furthermore, in some cultures and during specific public health events, there is a negative perception of contact-based fingerprinting. Contact based sensors are especially limited in medical applications where transfer of pathogens can occur through contact with common objects. Restricted areas such as intensive care units, operating rooms, pharmacy cabinets, and medical records often require authorization, but a contact based sensor conflicts with disease control practices.

Fingerprint sensors are typically used for authentication. In large subject databases, a singular fingerprint does not have the capability of being used for identification.

Face recognition is a biometric in increasing use. Traditional facial recognition algorithms identify facial features by extracting landmarks, or features, from an image of the subject's face. For example, an algorithm might analyze the relative position, size, and/or shape of the eyes, nose, cheekbones, and jaw. These features are then used to search for other images with matching features.

Three dimensional face recognition has received a good deal of attention recently and has claimed improved accuracies. This technique uses 3D sensors to capture information about the shape of a face. This information is then used to identify distinctive features on the surface of a face, such as the contour of the eye sockets, nose, and chin. One advantage of 3D facial recognition is that it is not affected by changes in lighting like other techniques. It can also identify a face from a range of viewing angles, including a profile view. Three-dimensional data points from a face vastly improve the precision of facial recognition. 3D research is enhanced by the development of sophisticated sensors that do a better job of capturing 3D face imagery. Historical sensors work by projecting structured light onto the face at one angle while capturing the image from another angle.

Hand Biometrics. Hand geometry recognition debuted in the market in the late 1980s. The systems are widely implemented for their ease of use, public acceptance, and integration capabilities. One of the shortcomings of the hand geometry characteristic is that it is not highly unique, limiting the applications of the hand geometry system to verification tasks only.

Hand geometry systems have the longest implementation history of all biometric modalities. David Sidlauskas developed and patented the hand geometry concept in 1985 and the first commercial hand geometry recognition systems became available the next year. The 1996 Olympic Games implemented hand geometry systems to control and protect physical access to the Olympic Village. Many companies implement hand geometry systems in parallel with time clocks for time and attendance purposes. Walt Disney World has used a similar “finger” geometry technology system for several years to expedite and facilitate entrance to the park and to identify guests as season ticket holders to prevent season ticket fraud.

The devices use a simple concept of measuring and recording the length, width, thickness, and surface area of an individual's hand while guided on a plate. Hand geometry systems use a camera to capture a silhouette image of the hand.

The hand of the subject is placed on the plate, palm down, and guided by five pegs that sense when the hand is in place. The resulting data is captured by a Charge-Coupled Device (CCD) camera of the top view of the hand including example distance measurements. The image captures both the top surface of the hand and a side image that is captured using an angled mirror.

The system used for image capture must be large enough to accommodate the hand of the individual. The requirement necessitates a large sampling area. Additionally, most systems use finger pegs to facilitate repeatability of the measurement.

Today, recognition systems based either on hand geometry or the palm print are still far less popular than other types of systems. This unpopularity is mainly due to the low user-friendliness that these systems present and that they are quite complex to use.

One significant constraint is the acquisition of images for the recognition task, since there are many limitations regarding the positioning of the hand during the acquisition. For example, the hand is typically placed in a certain position and pose and the fingers must be in a certain position. In some systems, pegs are used to force the user to place their hand in the position required. However, in addition to being uncomfortable, these pegs squash the hand, which subsequently influences the feature extraction. Other systems use a peg-free methodology where acquisition is conducted without pegs, which allows the user a little more freedom, but at the same time the hand must be in a specific position and if that position is not followed, recognition will fail or performance can be impacted.

Palmprint is a biometric method based upon the ridges, principal lines and wrinkles on the surface of the palm. The inner surface of the palm normally contains three flexion creases, secondary creases and ridges. The flexion creases are also called principal lines and the secondary creases are called wrinkles. The flexion and the major secondary creases are formed between the 3rd and 5th months of pregnancy and superficial lines appear after we born. Although the three major flexions are genetically dependent, most of other creases are not. Even identical twins have different palmprints. These non-genetically deterministic and complex patterns are very useful in personal identification.

Palmprint methods can utilize different features based upon the resolution of the image obtained. Higher resolution images enable extraction of ridges, singular points and minutia points as features, while lower resolution images may focus on principal lines, wrinkles and hand creases.

Palmprint biometrics benefit from the fact that the palm area is much larger than the fingerprint and hence has more distinctive features. The information rich palm makes it more even more suitable for a higher performing system with some identification capability. The major disadvantages of palmprint biometrics relates to the size of the physical system. Existing palmprint scanners are bulky and expensive since they need to capture a large area.

There is a need for a recognition system using biometric hand geometry and palm print without any restrictions on the positioning of the hand and where the hand can be rotated, tilted, inverted, with the fingers spread out or together and even with curvature in the fingers.

U.S. Pat. No. 8,175,346, titled “Whole-Hand Multispectral Biometric Imaging” describes a noncontact hand biometric imaging system. Examination of FIG. 1 in shows a multi-imaging system of significant size. The system uses multiple images 104 to create the information used for biometric identification.

U.S. Pat. No. 8,358,336, titled “Frontal Hand Capture of Fingerprints, Palm Prints and Hand Geometry Using Contactless Photography” discloses a system using a plurality of camera and lights to quickly capture biometric information. FIG. 1 of the patent show an example embodiment. Such a system could not be incorporated in a cellular phone.

U.S. Pat. No. 8,971,588 titled “Apparatus and method for contactless high resolution handprint capture” discloses a system for capturing a noncontact handprint image. The system captures multiple images over time at different focal lengths. The system uses a depth-from-defocus approach to extract a 3D map of the hand. The exposure time is less than 1/30 second with a total capture time of less than 5 seconds. The optical system as shown in FIG. 3 shows multiple optical elements.

U.S. Pat. No. 7,768,656 titled “System and Method for three-Dimensional Measurements of the Shape of Material Objects” is an example of traditional approaches to 3D measurement using light triangulation. As shown in FIG. 1 of the patent and FIG. 2 of this application, historical 3D measurement techniques are based upon a triangulation methodology. These system typically use some form of structured light. Phase shifted structured light techniques use 3 or more images of the subject with a pattern projected onto the subject from some angle, with a shift of the pattern between images. The projection angle and view angle must be different to create a triangulation effect.

FIG. 3 illustrates the triangulation approach used in U.S. Pat. No. 7,768,656 and commonly used with structured light systems. The center 124 of the entrance and exit pupils of the projection lens 181 of the projector 106 are in one or more embodiments the vertex of the projected structured light 113, while the center 130 of the entrance and exit pupils of the lens 180 of the camera 108 are in one or more embodiments the vertex of the camera field of view 118.

Through the use of a triangulation method, a plurality of points in the slide 122 are projected onto the surface 110 of an object 111 and then mapped one-to-one to respective points in the captured image that is captured by the camera 108. The position of each point in the captured image depends on a variety of factors, such as the distance to the surface 110 of object 111 and the shape and orientation of the surface 110 in relation to the optical unit 102. In order to reconstruct the shape and position of the surface 110 being measured, each point in the captured image is associated with a respective point in the slide 122 and then the shape, position and/or orientation of the surface 110 is derived from the coordinates of the points using triangulation techniques known to those skilled in the art. FIG. 3 illustrates a method of calculating the shape of a surface 110 at a certain point based on the corresponding points on the slide 122 and on the captured image at the receiver 128.

The result of such measurements is a detailed 3D object measurement. U.S. Pat. No. 7,768,656 uses structured light triangulation but uses a structured slight pattern with different types of lines to help address the correspondence issue between the structured light pattern on a flat image and the structured light pattern on the object to be measured. The use of different types of structured light patterns is covered in the article by Joaquim Salvi, Sergio Fernandez, Tomislav Pribanic, and Xavier Llado. 2010. A state of the art in structured light patterns for surface profilometry. Pattern Recogn. 43, 8 (August 2010), 2666-2680.

In general, some form of structured light triangulation is used for 3D surface reconstruction. The article by Geng, Jason, titled “Structured-light 3D surface imaging: a tutorial.” Advances in Optics and Photonics 3.2 (2011): 128-160, provides a summary of the approach with a comprehensive list of known variances. The triangulation approach requires separation between the camera and the projector used to create the structured light image. The system requires that the projector optical axis 112 and the camera optical axis 116 intersect within the depth of field of the camera. The depth of field, also called focus range or effective focus range, is the distance between the nearest and farthest objects in a scene that appear acceptably sharp in an image. Having an intersection point outside of the depth of field is of little value since the image of the object is blurred, by the definition of the depth of field. In general the depth resolution capabilities of the system are dependent in part of the degree of intersection present. The greater the intersecting angle, the better the depth of resolution. The angle of intersection is then dependent upon the separation of the projector from the camera. It is also important to note that the greater the angle of intersection, the greater the amount of shadow present in the image. Specifically, the camera can only capture surfaces visible to the camera. For example, examination of FIG. 4 shows that approximately half the face is in shadow.

### BRIEF DESCRIPTION OF THE DRAWINGS

The accompanying drawings, which are incorporated in and form part of the specification, illustrate the present invention and, together with the description, describe the invention.

FIG. 1 is an illustration of an example embodiment of biometric system on cellular phone.

FIG. 2 is an illustration of a typical configuration used for optical depth determination by triangulation.

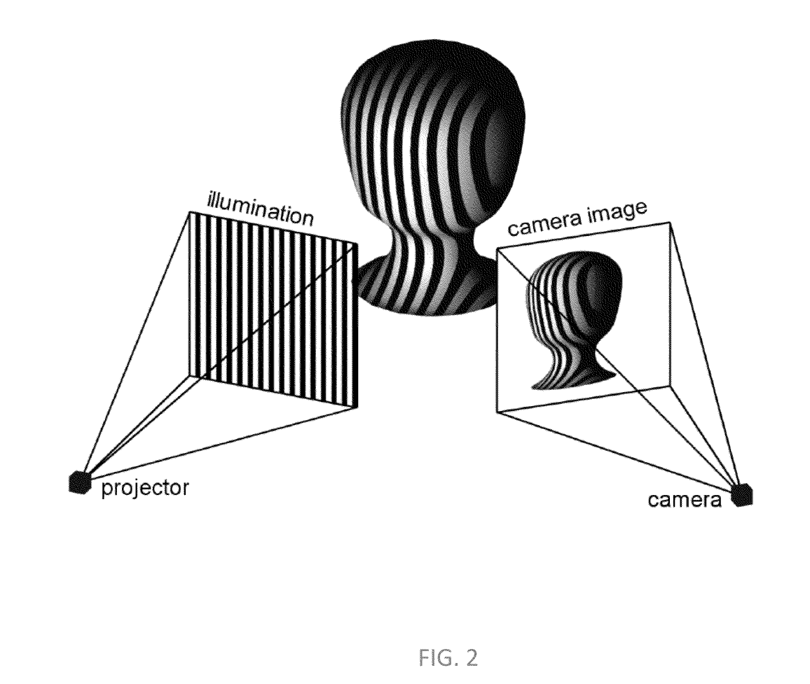

FIG. 3 is an illustration of geometric relationships used with triangulation method.

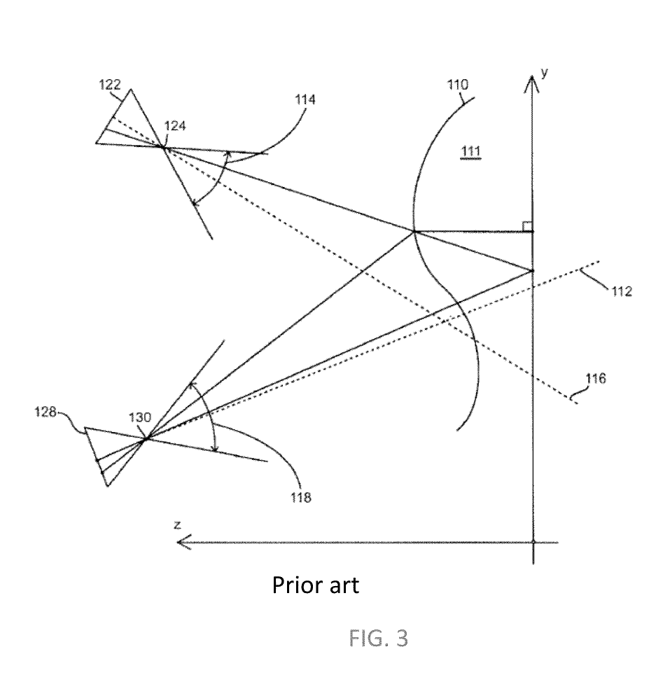

FIG. 4 is an illustration of a structured light image with shadows present on face.

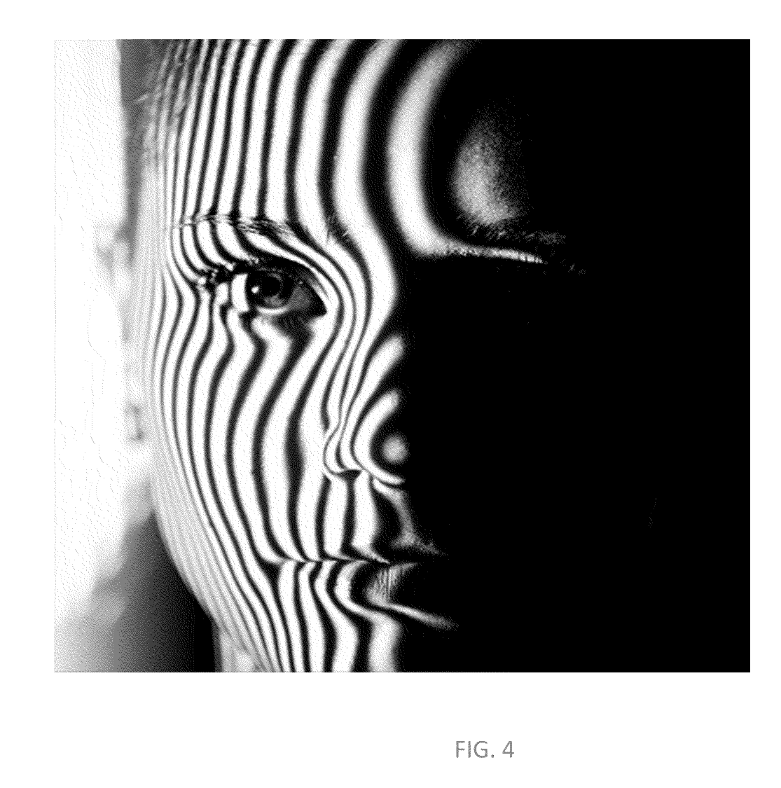

FIG. 5 is an illustration of a point cloud of a hand.

FIG. 6 is an illustration of the types of measurements used for hand biometric identification.

FIG. 7 is an illustration of finger length determination when finger is not straight.

FIG. 8 is an illustration of the types of parameters that can be calculated from hand image.

FIG. 9 is an illustration of the types of biometric information that can be extracted from a hand image.

FIG. 10 is an illustration of a depth map of a butterfly created by light field camera.

FIG. 11 is an illustration of head images acquires with a light field camera with and without grid illumination.

FIG. 12 is an illustration of the depth contour image calculated for a light field images.

FIG. 13 is an illustration of depth map presented in x,y,z coordinate space.

FIG. 14 is an illustration of image and associated depth map of side of manikin face.

FIG. 15 is an illustration of image and associated depth map of side and front of manikin face.

FIG. 16 is an illustration of image and associated depth map of front of manikin face.

FIG. 17 is an illustration of parallel axis system.

FIG. 18 is an illustration of grid pattern divergence.

FIG. 19 is an illustration of two balls illuminated with grid pattern.

FIG. 20 is an illustration of dot pattern at different distances form camera.

FIG. 21 is an illustration of dot pattern and associated coordinate points at one distance.

FIG. 22 is an illustration of coordinate points at all distances.

FIG. 23 is an illustration of a zoomed image of grid intersection points at different distances.

FIG. 24 is an illustration of grid calibration process.

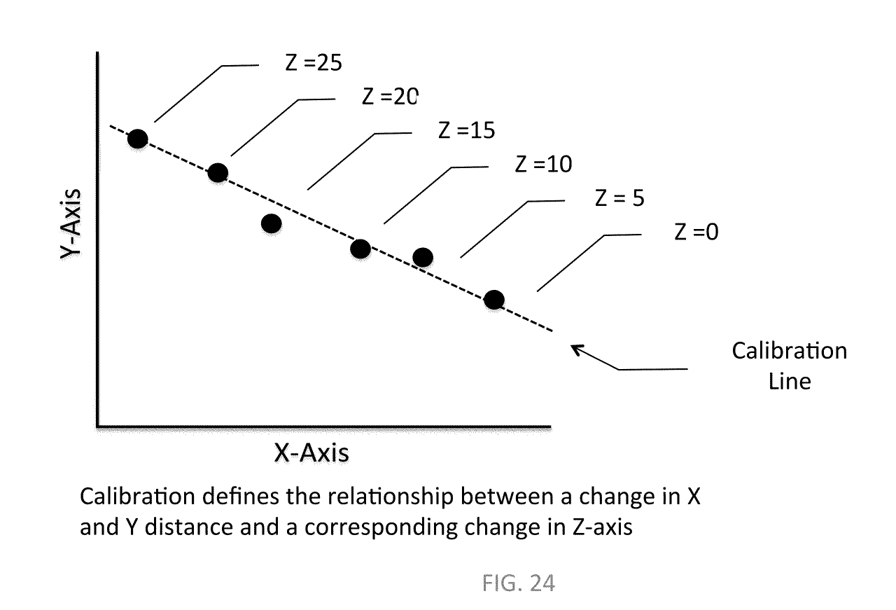

FIG. 25 is an illustration of grid calibration used to determine z-axis of new intersection point.

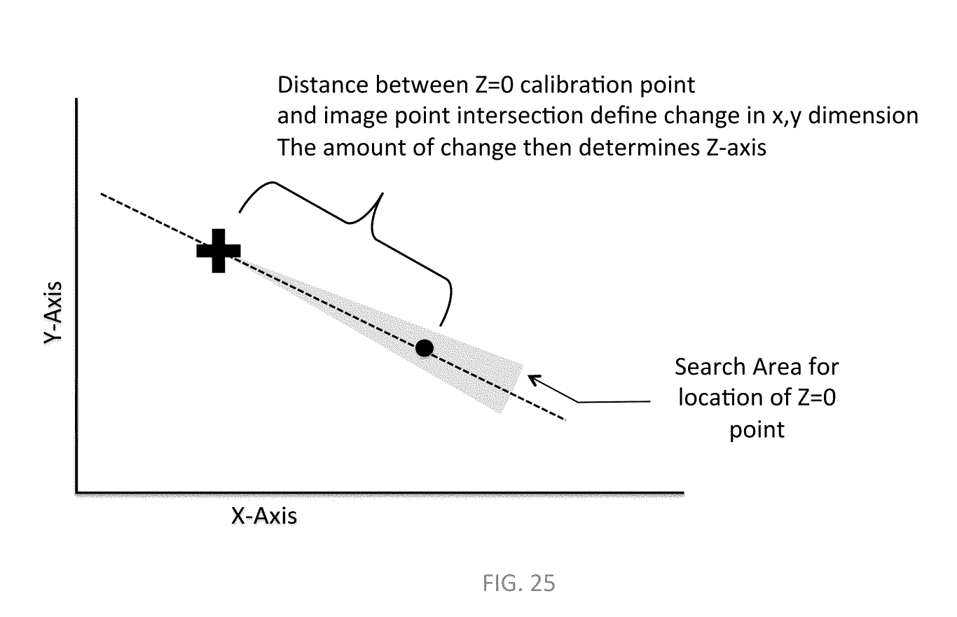

FIG. 26 is an illustration of hand image.

FIG. 27 is an illustration of hand intersection points.

FIG. 28 is an illustration of hand depth map.

FIG. 29 is an illustration of head manikin with grid illumination.

FIG. 30 is an illustration of cropped images as used in grid projection method.

FIG. 31 is an illustration of the two sub-image placement methods.

FIG. 32 is an illustration of an illustration of how the grid match method works.

FIG. 33 is an illustration of the sub-images used for matching.

FIG. 34 is an illustration of an example depth map generated by the grid match method.

FIG. 35 is an illustration of hand movement over biometric system.

FIG. 36 is an illustration of grid rotation during sampling.

FIG. 37 is an illustration of grid pattern using variable frequency grid lines.

FIG. 38 is an illustration of a mask used to locate hand image.

FIG. 39 is an illustration of the raw RGB signal obtained from the hand.

FIG. 40 is an illustration of processed signal obtained from the hand.

FIG. 41 is an illustration of the final pulse signal obtained from the hand.

FIG. 42 is an illustration of the skeletal models used for hand animation.

FIG. 43 is an illustration of a composite image showing an all in focus palm and hand print.

FIG. 44 is an illustration of a processing method using distributed processing locations.

FIG. 45 is an illustration of a system embodiment utilizing two projectors on a cellular phone.

### DESCRIPTION OF THE INVENTION

Terms used in the description. Authentication is the act of confirming the truth of an attribute of a single piece of data (datum) or entity. In contrast with Identification which refers to the act of stating or otherwise indicating a claim purportedly attesting to a person or thing's identity, Authentication is the process of actually confirming that identity. It might involve confirming the identity of a person by validating their identity documents, verifying the validity of a website with a digital certificate, tracing the age of an artifact by carbon dating, or ensuring that a product is what its packaging and labeling claim to be. In other words, Authentication often involves verifying the validity of at least one form of identification.

The process of authorization is distinct from that of authentication. Whereas authentication is the process of verifying that “you are who you say you are”, authorization is the process of verifying that “you are permitted to do what you are trying to do”. Authorization thus presupposes authentication.

For ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light field data. Such a data acquisition device can include optics, sensors, and image processing electronics for acquiring data representative of a scene, using techniques that are well known in the art, are disclosed herein, or could be conceived by a person of skill in the art with the aid of the present disclosure.

One skilled in the art will recognize that many types of data acquisition devices can be used, and that the system and method described herein are not limited to cameras. Thus, the use of the term “camera” herein is intended to be illustrative and exemplary, but should not be considered to limit scope. Specifically, any use of such term herein should be considered to refer to any suitable device for acquiring image data.

For ease of nomenclature, a light field camera or light field data acquisition device is any device that can obtain, acquire, generate, manipulate and/or edit (for example, adjust, select, define and/or redefine the focus and/or depth of field—after initial acquisition or recording of the image data and/or information) image data and/or information of, for example, a scene.

In the present description and in the claims, the term “depth map” refers to a representation of a scene as a two-dimensional matrix of pixels, in which each pixel corresponds to a respective location in the scene and has a respective pixel depth value, indicative of the distance from a certain reference location to the respective scene location. In other words, the depth map has the form of an image in which the pixel values indicate topographical information, rather than brightness and/or color of the objects in the scene. The terms “depth map” and “3D map” are used herein interchangeably and have the same meaning.

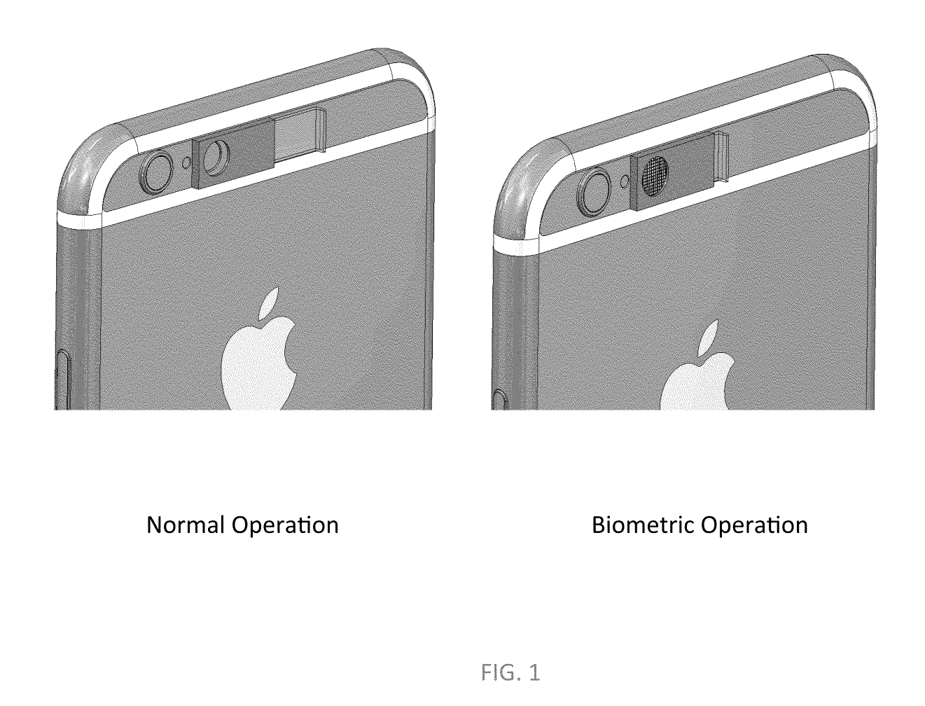

The present invention relates to a hand and face biometric that occupies a very small footprint and can have a form factor compatible with cellular phones. The biometric system can be incorporated into the cellular phone during manufacture or added to the device afterwards. The addition of the biometric system can be a simple as adding a small attachment over the flash led, . Additionally, the noncontact features of the system help address concerns associated with infectious disease transmission as well as latent prints. Latent prints are prints that remain after a finger touches a surface. The invention create a biometric system that can be implemented on a cellular phone for improved biometric performance, as shown in FIG. 1. Embodiments of the invention can provide a high performing biometric using the existing camera system on a phone with only minor modification, requiring only a small footprint for a secure biometric for use with secure transactions. Such an embodiment can decrease fraudulent activities.

Such a system can be used to accurately authenticate the user. With cellular phones being used to access bank accounts and used for direct payment, an improved biometric capability is clearly needed.

The realization of such a system can be difficult since the hand or face is not constrained by the sampling platen and can be rotated, and tilted. Additionally, curved fingers or different facial expressions can added additional complexity. However, accurate depth maps obtained through optical methods can be used to create accurate 3D models. These models than then be used by the biometric algorithm for accurate identification or authorization.

An example embodiment that can create a depth map uses light field image technology. In general terms, light field image technologies create an information package that capture the entire light field. The light field contains image information at multiple depths. This information package enables the development of a depth map and the ability to focus the image at multiple focal planes. A depth map defines the relationship between objects in the image field and the camera. These characteristics of a light field image allows for compensation of hand location sampling errors that can occur with a noncontact system. Sampling errors can include tilt of the hand, rotation of the hand, curvature of the hand, etc. The cameras that capture a light field provide a unique opportunity for the development of a noncontact biometric.

The depth map information contained in a light field image can be leveraged by using depth dependent image filters, extended depth-of-field, simulation of different focal lengths, simple separation of fore and background, and selective change of the focus plane. Additionally, the depth field information can be used to create a 3D imprint models of the hand and face. The three dimensional information can then be used to extract accurate biometric features in the presence of significant variances in hand presentation. In a noncontact sampling system, the hand is not constrained by the sampling platen and can be rotated, tilted, and fingers curved relative to the sampling device. The second key attribute of a light field camera is the ability to refocus the image for the creation of an “all in focus” image despite differences in the location of the object from the camera. The use of a system that contains more information than a single image at a single focus proves the need additional information that can be used to effectively compensate for sampling errors.

The use of a light field image data allows the biometric process to use three dimensional information instead of 2D information. This additional axis of information can be used to create a superior biometric platform. 3D systems are much harder to spoof, and provide the ability to extract additional information allowing for better identification.

Because the system is image based, the physical size of the camera can be small while still allowing the system to sample the entire hand. This creates the opportunity to use the system in a smart phone, laptop computer or other mobile systems.

Another example embodiment uses a parallel axis system grid distortion system. The parallel axis component of the system relates to the configuration wherein the projector optical axis and the camera optical axis are parallel and do not intersect. The grid distortion element of the system relates to the fact that a parallel projected grid will distort as a function of the underlying topography of the object upon which the grid is projected. The details of both aspects will be described in the context of example embodiments.

In addition to a small footprint, the present invention does not require that the operator maintain the hand in a stable position. Multiple images will be obtained during a given measurement period. Thus, the fidelity of the biometric information can be improved by using multiple images and through super resolution methods.

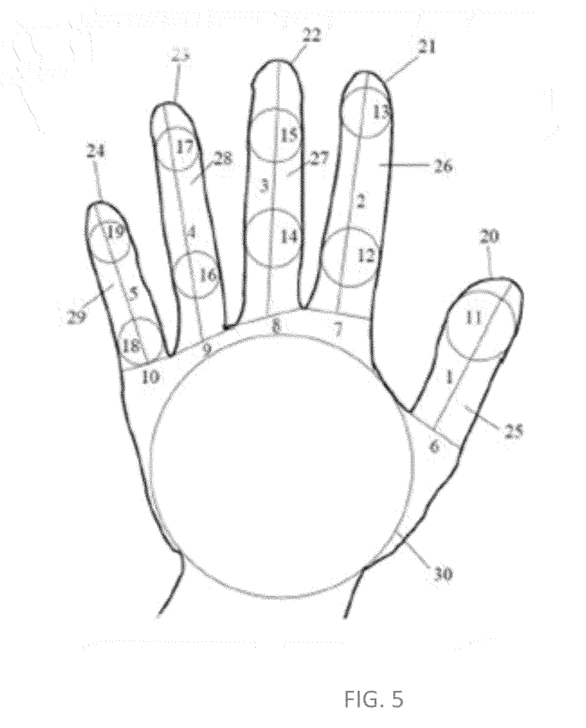

Biometric Measurements. Most hand geometry systems are based upon measurements like those shown in FIG. 5. These systems use a simple concept of measuring and recording the length, width, thickness, and surface area of an individual's hand while guided on a platen. Conventional hand geometry systems use a camera to capture a silhouette image of the hand. In typical applications, the hand of the subject is placed on the plate, palm down, and guided by five pegs that sense when the hand is in place. The resulting image is captured by a Charge-Coupled Device (CCD) camera of the top view of the hand including example distance measurements. In some applications, the data acquisition process includes image capture of both the top surface of the hand and a side image that is captured using an angled mirror. Upon capture of the silhouette image, the image is analyzed and up to 90 measurements are taken; the measurements range from the length of the fingers, to the distance between knuckles, size of knuckles and palm size. This measurements are used to complete the authentication process. The peer review publication by Svoboda, Jan, Ond\check{r}ej Klubal, and M. Drahansky. “Biometric recognition of people by 3D hand geometry.” Digital Technologies (DT), 2013 International Conference on. 2013 provides an excellent overview of hand biometrics.

Face biometrics. Face recognition uses the spatial geometry of distinguishing features of the face. It is a form of computer vision that uses the face to identify or to authenticate a person.

An important difference with other biometric solutions is that faces can be captured from some distance away, with for example surveillance cameras. Therefore face recognition can be applied without the subject knowing that he is being observed. This makes face recognition suitable for applications such as finding missing children or tracking down fugitive criminals using surveillance cameras.

Face recognition is based upon the spatial geometry of the face. Although there are variations in approach, face recognition is generally accomplished via the following steps:

A digital camera acquires an image of the face.

Software locates the face in the image, this is also called face detection.

When a face has been selected in the image, the software analyzes the spatial geometry. The techniques used to extract identifying features of a face are vendor dependent. In general the software generates a template, this is a reduced set of data which uniquely identifies an individual based on the features of his face.

The generated template is then compared with a set of known templates in a database (identification) or with one specific template (authentication).

The software generates a score which indicates how well two templates match. It depends on the software how high a score must be for two templates to be considered as matching, for example an authentication application requires low FAR (false approval rate) and thus the score must be high enough before templates can be declared as matching. In a surveillance application however you would not want to miss out on any fugitive criminals thus requiring a low FRR (false rejection rate), so you would set a lower matching score and security agents will sort out the false positives.

The present invention can effectively deal with sampling variance, so there is not a requirement for the face to be aligned by an external system as in previous systems. The present invention provides an effective noncontact biometric system, with embodiments providing one or more of the following capabilities.

Depth map. The ability to locate the hand in space, including fingers and palm, in a noncontact manner is an important element for the effective measurement of hand geometry parameters when sampling errors are present. For face recognition, 3D face renderings have been shown to be superior to 2D systems.

A depth map is an image or image channel that contains information relating to the distance of the surfaces of scene objects from a viewpoint, typically the camera. The term is related to and can be analogous to depth buffer, Z-buffer, Z-buffering and Z-depth. The “Z” in these latter terms relates to a convention that the central axis of view of a camera is in the direction of the camera's Z axis, and not to the absolute Z axis of a scene.

As stated previously, a noncontact system does not locate or constrain the object under examination. Thus, the object might be tilted or slightly rotated relative to a prior measurement. The variability in object location can be considered as sampling error. The object is not reproducibly located resulting in a sampling variance or error. The present invention provides a system that can effectively compensate for this type of sampling variance, a major advantage over previous systems.

The creation of an accurate depth map allows the system to locate the object effectively in three dimensional space. The ability to define the location of the object allows for the system to be moved to the same location or for determination of accurate dimensions regardless of the original location.

Construction of 3D Imprint or 3D Representation. The depth information obtained from the hand image or face image can be used to create a 3D imprint representation. There are many methods of 3D representation but a common method is the creation of a point cloud. A point cloud is a set of data points in some coordinate system. In a three-dimensional coordinate system, these points are usually defined by X, Y, and Z coordinates, and often are intended to represent the external surface of an object.

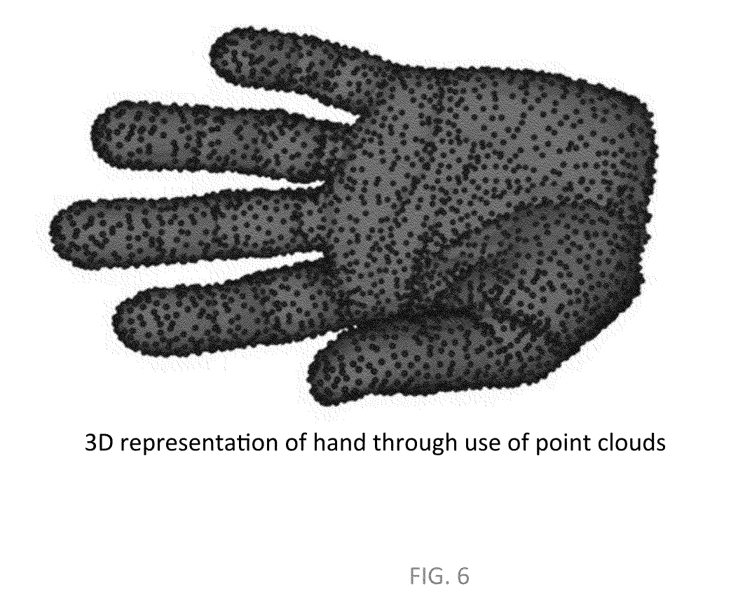

The depth information obtained can be used to create a point cloud which effectively represents an imprint of the hand. This information can then be used to define the dimensional aspects of the hand in space. See FIG. 6 as an example of a point cloud associated with a hand.

The ability to create a location defined imprint of the hand or face is an important step in addressing the sampling errors present with a noncontact system. Specifically, it allows the system to know the physical location of the hand or face relative to the camera in a known coordinate space. This information can then be used to extract accurate features for use with a biometric system.

All in focus image. Both dimensional determination as well as palmprint biometrics are facilitated by clear images. The invention provides a method for acquiring images that have the clarity or sharpness needed for use in palmprints.

Extraction of Biometric Features. The ability to derive a three dimensional object representation allows for the calculation of key biometric parameters. The determination of the key hand biometric geometries can be done by several methods that can be used in combination or individually.

The ability to accurately define hand dimensions, perform crease detection, and move or reposition the hand leverages work done in skeleton animation, gesture recognition, virtual reality, simulation, and entertainment applications. These methods use 3D modeling techniques in an effort to create realistic representations of the human hand.

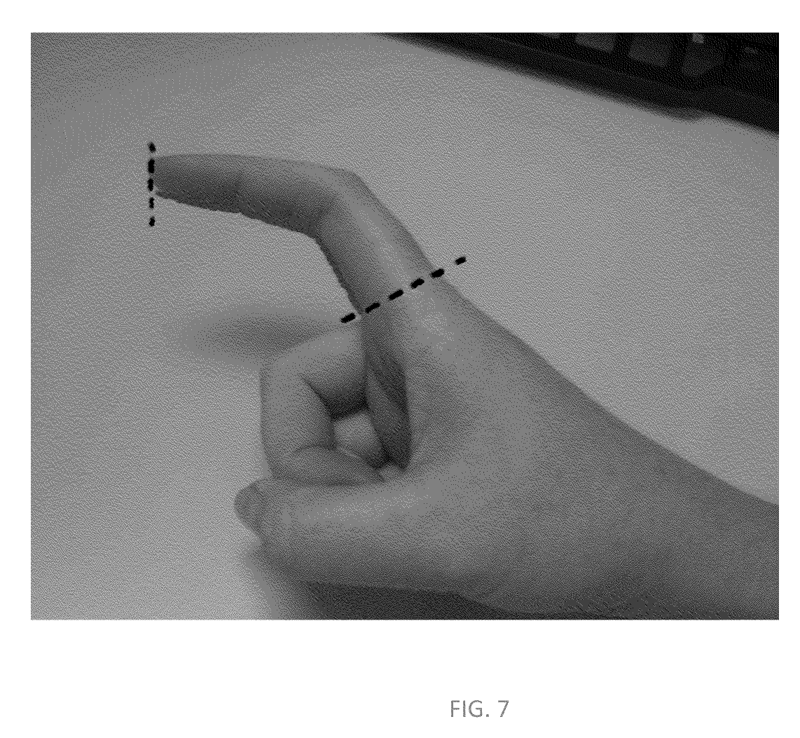

In a simplistic manner, 3D model distance determination can be done by determining the distance along a surface. The length of the finger can be determined along the model surface. See FIG. 7 as a simplistic example. To facilitate the process a 2D image projection can be used for detection of creases and end points. Additionally, the 3D model or point cloud can be rotated in space such that the distance measurement is made in a manner that is normal to the surface of measurement.

Rhee et al describe a method for taking a flat 2D image and creating a 3D hand model, (Taehyun Rhee, Ulrich Neumann, and J. P. Lewis. 2006. Human hand modeling from surface anatomy. In Proceedings of the 2006 symposium on Interactive 3D graphics and games (13D '06). ACM, New York, N.Y., USA, 27-34). The paper is incorporated by reference. The process presented is not applicable to the biometric problem but several concepts described in the paper have value.

Embodiments of the present invention provide for biometric feature extraction using the depth map information and the all in focus image to extract key biometric parameters. Surface anatomy feature-extraction methods are used to extract the main creases on the palmar skin, joint creases and the hand geometry. Edge detection technology can be used to define finger and hand boundaries. The joint structure can then be estimated from an anatomical analysis of the relationships between the surface anatomy and its osseous structure.

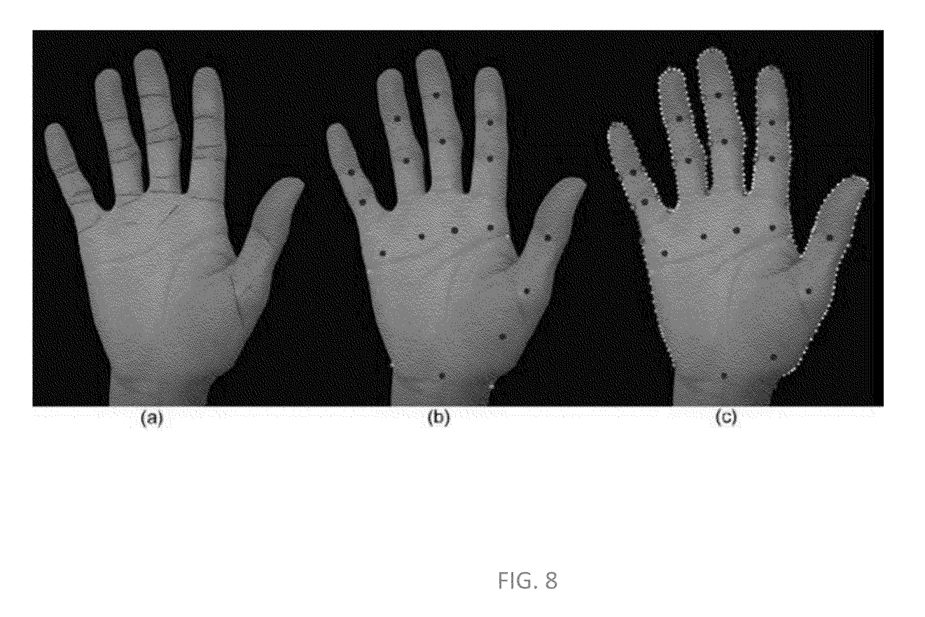

FIG. 8 shows ad example of the information that can be effectively extracted. The figure shows (a) palm and finger joint creases, (b) estimated hand joints, while (c) the dots represent curve segments. This type of processing can then enable the determination of the parameters as previously shown in FIG. 5.

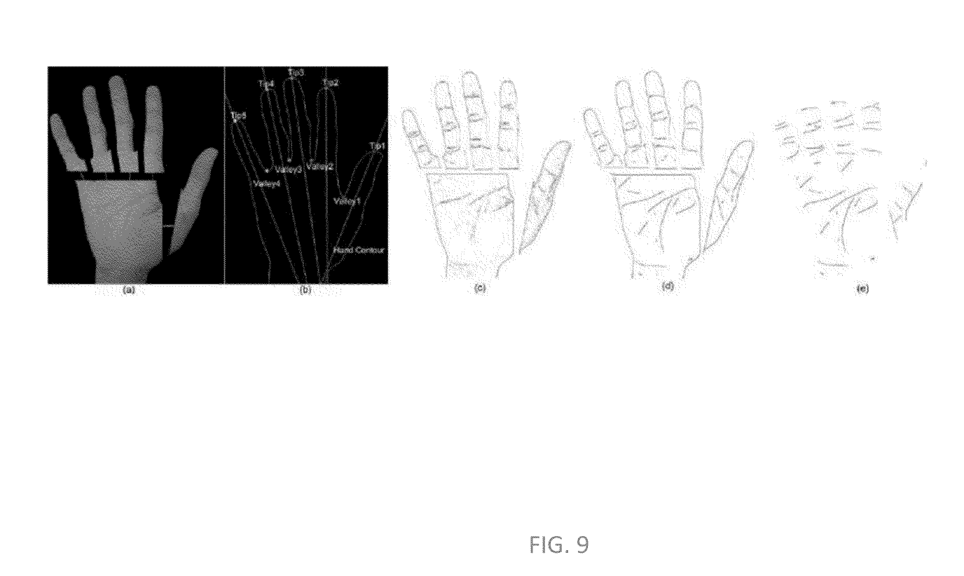

The image information as well as the depth map can be processed to create set of parameters that can be used for biometric identification. FIG. 9 is an example of such a progression to determine palm crease information. FIG. 9 shows (a) Segmented hand image, (b) Basic hand geometry; contour of the hand, five finger tips, four finger valleys, and medial axis of each finger, (c) Sobel edge image, (d) First tensor voting result, (e) Second tensor voting result (final result). The final result of the processing method is the set of salient wrinkle curves and each curve is smooth and mostly continuous.

The result of the above processing method is an extraction process that provides information on finger length, wrinkle extraction, palm creases, finger creases, joint modeling and the curvature of each finger segment. These parameters can be determined despite variances in the positioning of the hand relative to the camera.

Face recognition involves a similar process where key dimensions are defined and the overall topography of the face defined. A summary of these methods can be found in Al-Osaimi, Faisal Radhi M., and Mohammed Bennammoun. “3D Face Surface Analysis and Recognition Based on Facial Surface Features.” 3D Face Modeling, Analysis and Recognition (2013): 39-76, which is incorporated herein by reference.

Light Field Camera example embodiment. Light field cameras (also called plenoptic cameras) have recently attracted significant attention. These cameras differ from traditional 2D camera by capturing the entire light field. Specifically, light field cameras can capture scene depth. The increasing importance of this passive depth acquisition technology is illustrated by the emergence of light field camera companies like Lytro (www.lytro.com), Raytrix (www.ratrix.com)and Pelican Imaging (www.pelicanimaging.com). The PhD dissertation by Ren Ng titled “Digital Light Field Photography” gives an overview of microlens based light fieldcameras.

The technologies capable of capturing scene depth or a light field images continues to evolve but is generally divided into these general subdivisions:

Microlens array: the camera uses a microlens array to capture 4D light field. The lenslet array is in front of the sensor such that the main lens is focused on the lenslet array and the lenslet array is focused on the sensor. This is the approach used by Lytro and Raytrix.

Multifocal systems: the camera system captures a single image but the image contains multiple sub images. The Adobe prototype light-field camera acquires 19 pictures at different focal planes. Each of its lenses is faced with a prism set at a unique angle, so it can take 19 pictures simultaneously, with each capturing a different part of the scene in focus. Each image uses a piece of the sensor, so a 100-megapixel camera will yield 19 5.2-megapixel shots.

Focus stacking: the camera is used in a conventional mode but the method utilizes a digital image processing technique which combines multiple images taken at different focus distances to give a resulting image with a greater depth of field (DOF) than any of the individual source images. Focus stacking is also known as focal plane merging, z-stacking or focus blending. Focus stacking can be used in any situation where individual images have a shallow depth of field; macro photography and optical microscopy are two typical examples. Focus stacking offers flexibility: as focus stacking is a computational technique, images with several different depths of field can be generated in post-processing and compared for best artistic merit or scientific clarity. Focus stacking also allows generation of images physically impossible with normal imaging equipment; images with nonplanar focus regions can be generated. FocusTwist is an iPhone application that uses focus stacking to create a light field type effect using an iPhone. A limitation of focus stacking is the time separation between the images acquired.

Compressive Light Field Photography: is a method based upon using a standard 2D camera, a physical mask and reconstruction methods. The system is composed of three key components: light field atoms as a sparse representation of natural light fields, an optical design that allows for capturing optimized 2D light field projections, and robust sparse reconstruction methods to recover a 4D light field from a single coded 2D projection. The approach uses a dappled attenuated mask with millions of little printed codes such that the enable the system to rebuild the entire scene in all three dimensions. The technique is described in the publication, “Compressive Light Field Photography using Overcomplete Dictionaries and Optimized Projections” by Kshitij Marwah, Gordon Wetzstein, Yosuke Bando, and Ramesh Raskar. In all cases, the information captured contains information needed to create a light fieldimage.

In optics, particularly as it relates to film and photography, depth of field (DOF) is the distance between the nearest and farthest objects in a scene that appear acceptably sharp in an image. Although a lens can precisely focus at only one distance at a time, the decrease in sharpness is gradual on each side of the focused distance, so that within the DOF, the unsharpness is imperceptible under normal viewing conditions. The area within the depth of field appears sharp, while the areas in front of and beyond the depth of field appear blurry.

In some cases, it may be desirable to have the entire image sharp, and a large DOF is appropriate. In other cases, a small DOF may be more effective, emphasizing the subject while de-emphasizing the foreground and background. In cinematography, a large DOF is often called deep focus, and a small DOF is often called shallow focus.

In example embodiments of the present noncontact biometric system, the information captured by the above techniques create or provide a light field image. This image can be processed to create a noncontact biometric based on the following capabilities:

The ability to obtain images at multiple focal planes creating a “all in focus image” capability;

The ability to create depth maps of the hand.

Depth maps can be obtained by combining both defocus and correspondence depth cues. Michael W. Tao, Sunil Hadap, Jitendra Malik, and Ravi Ramamoorthi. “Depth from Combining Defocus and Correspondence Using light-Field Cameras”, December 2013 describe one such method . The paper is incorporated herein by reference. The paper presents an algorithm that extracts, analyzes, and combines both defocus and correspondence depth cues. Using principled approaches, they show that de-focus depth cues are obtained by computing the horizontal (spatial) variance after vertical (angular) integration of the epipolar image, and correspondence depth cues by computing the vertical (angular) variance. By exploiting the advantages of both cues, light field data can used to create high quality depth maps in a single shot capture.

The creation of accurate depth maps is enhanced by artificially adding structure to the image. For example, a diffuse flat wall is a challenge due the lack of vertical or horizontal variance. A highly structured image pattern facilitates accurate creation of depth maps.

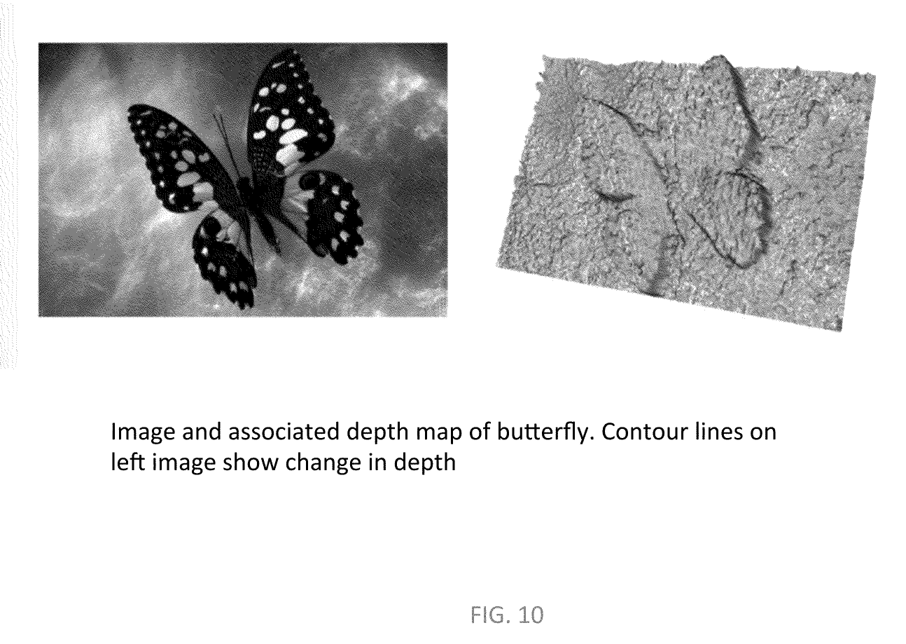

FIG. 10 shows a depth profile of a butterfly. The capability of creating a 3D imprint of an object is easily appreciated by examination of these images.

Additional features of light field images are:

Software Refocus: One of the most prominent and popular features of a light field camera is the possibility to change or set the focus after the picture is taken. Software Refocus is available with cameras by Lytro and Raytrix, the latter even offers pixel-precise focus as a software add-on.

All in Focus: capabilities allow realization of an image that is in focus despite the distance from the camera. Since virtually every pixel in the light field picture can be focused upon, we also have all the information necessary to create a picture with infinite depth of field, i.e. a picture where everything is in focus.

Variable Depth of Field: The intermediate of the two above features is variable depth of field: the operator can not only choose the focal plane, but also and how much of what's before and behind the plane is still in focus. This enables the system to maintain the image that satisfies a specific requirements relative to a defined focal plan of set of focal planes. Raytrix software offers this feature under the name “Extended Depth of Field”.

Perspective Shift/Parallax: Perspective shift/parallax is accomplished by selecting Lightrays that travel through different parts of the main lens system; you can move the perspective around a bit. In other words, you can “tilt your head” a little bit in every direction—virtually, and after the picture was taken. The strength of this parallax effect is dependent largely on the diameter of the main lens system

3D—Single-lens, single-shot: 3D images can be reconstructed with a single picture from a single lens. A light field camera creates a 3D image in all dimensions. A conventional two-lens 3D recording does not allow rotate of the picture while maintaining a full 3D effect.

Distance Measurement: By effectively processing the available data, the actual, absolute distance of objects within the image can be calculated relative to the lens. This capability has been used from inspecting manufactured parts (quality assurance) to measuring the dimensions of microscopic samples. “3D depth estimation” is available for Raytrix cameras as an add-on.

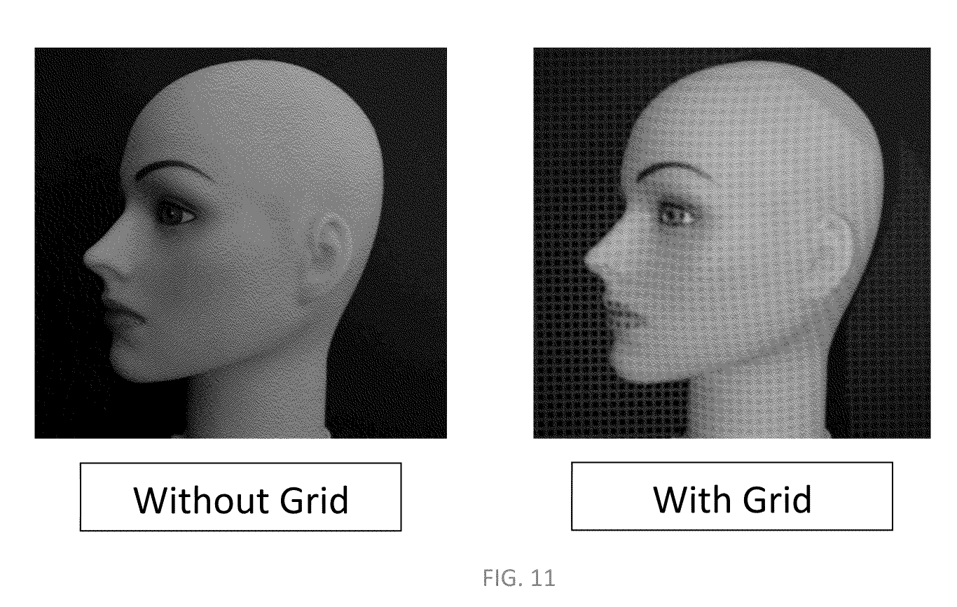

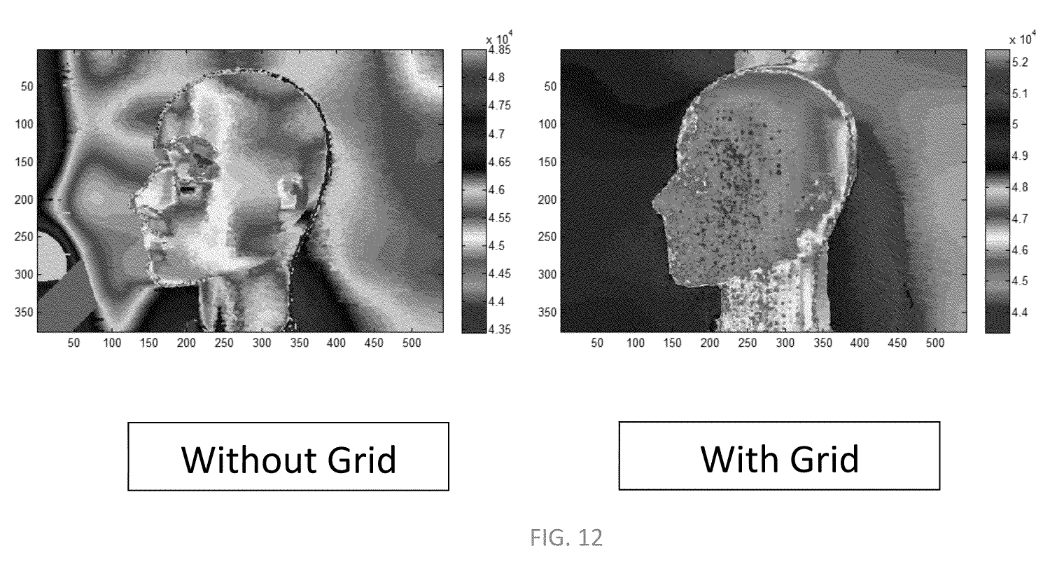

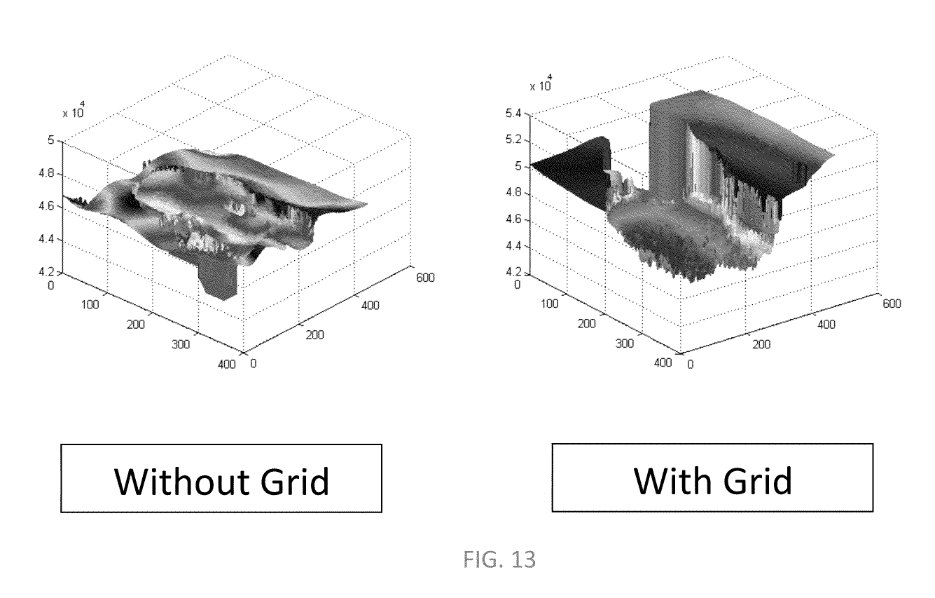

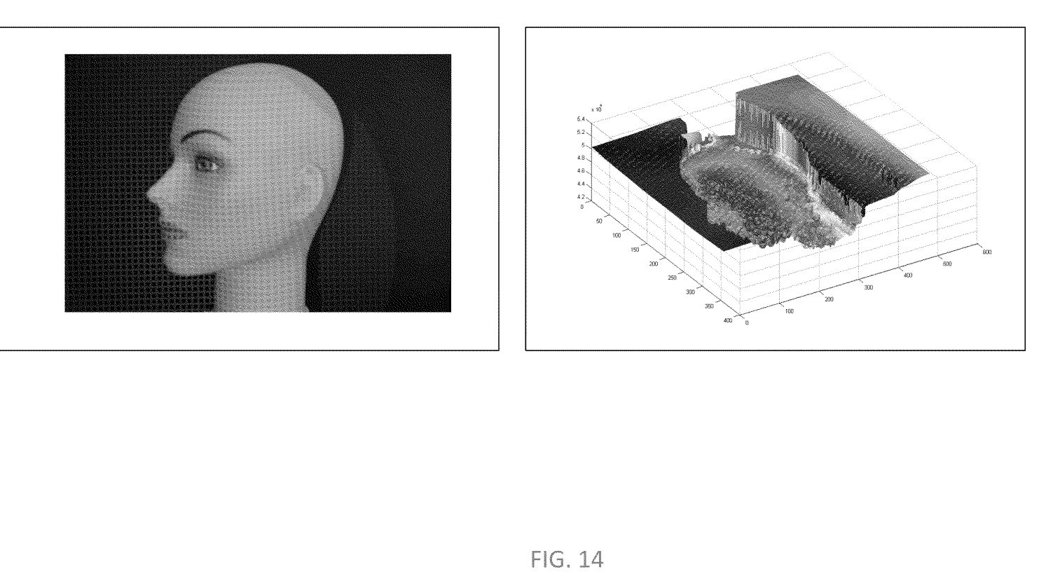

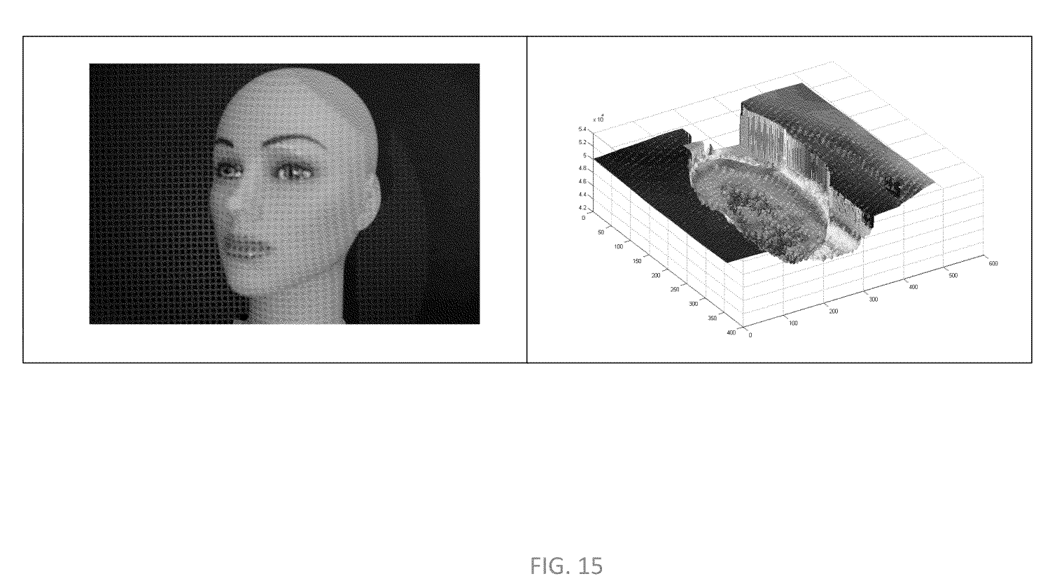

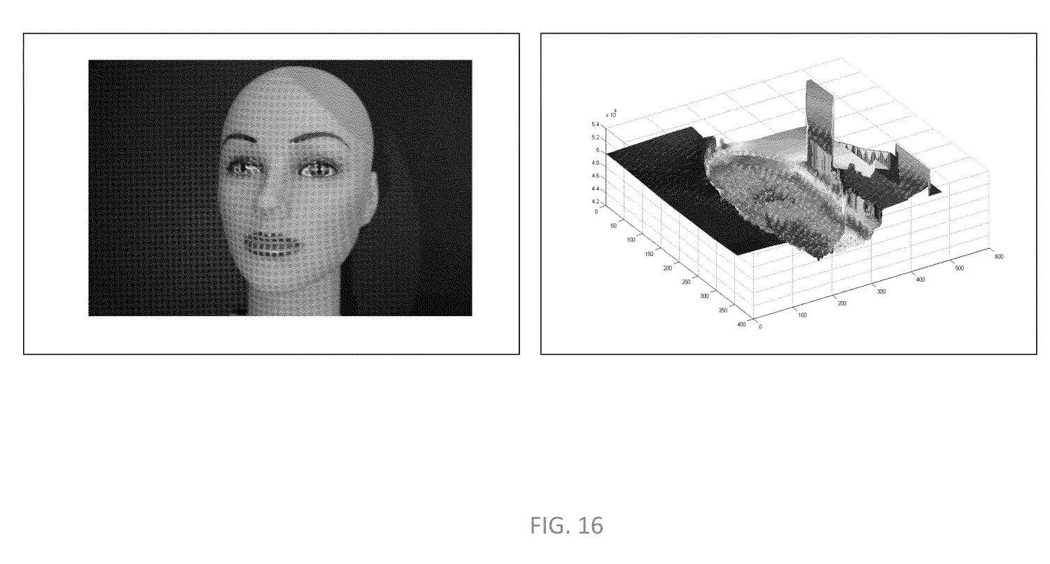

Light Field Example Embodiment. FIG. 11 shows the light field image of a head manikin with and without a grid projection. FIG. 12 shows a contour map while FIG. 13 is the resulting depth map for the two images. The left image obtained from the image with the grid projection shows improved image resolution. This improvement is anticipated due to the additional information content in the image. FIGS. 14, 15 and 16 show the image and associated depth map for the manikin as the head is rotated. The calculation of a depth map for a light field data acquisition device is dependent on many factors and the enclosed example ate simply examples to demonstrate the capabilities of the system. Multiple avenues exist for improved measurement results.

Improvements in performance of the depth map are possible. Bok, Yunsu, Hae-Gon Jeon, and In So Kweon. “Geometric Calibration of Micro-Lens-Based Light-Field Cameras Using Line Features.” Computer Vision-ECCV 2014. Springer International Publishing, 2014. 47-61, describe methods for improvement in the quality of the depth map.

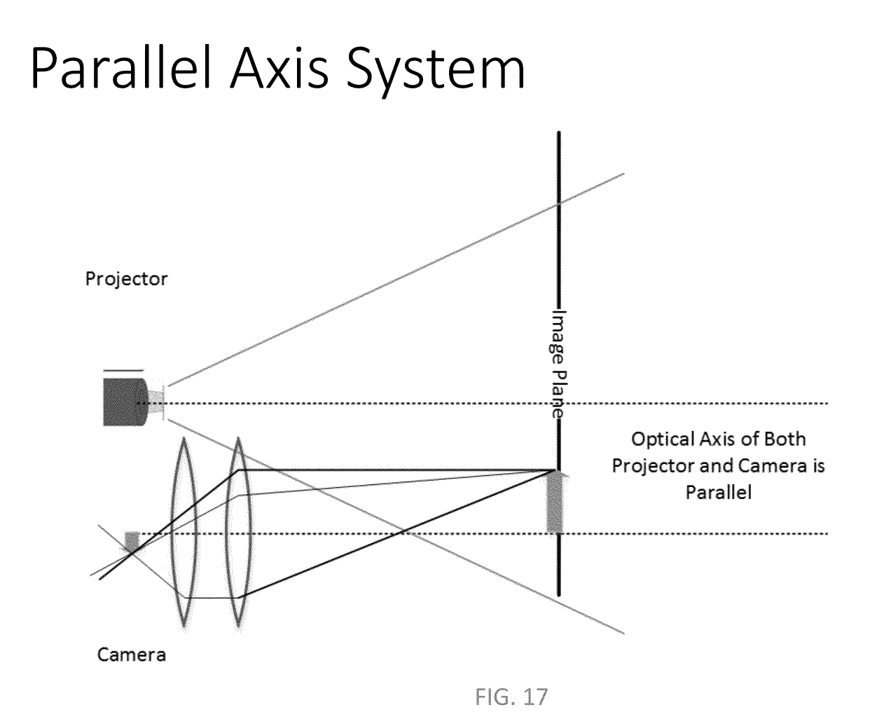

Parallel Axis Grid Distortion System. A biometric system that can be attached to an existing cellular phone should satisfy a number of significant constraints. As an example, the use of standard triangulation techniques cannot be used due to space limitations. The example embodiments described here are a “parallel axis system” which does not require an intersection between the optical axis of the light projection device and the optical axis of the camera within the depth of field. FIG. 17 shows a pictorial representation of such a system. The optical axis of the camera and the light projection system are parallel in this configuration. In this configuration the grid pattern is projected onto the object. The object image with illumination by the grid pattern is then captured by the camera. This technique requires that only one image be taken from the camera. As a result, the system can measure a moving hand or face.

Although referred to as a parallel axis grid system, one of ordinary skill in the art will appreciate that exact parallel alignment is not strictly required. In fact, the two optical axes may converge slightly but do not intersect within the camera depth of field[1].

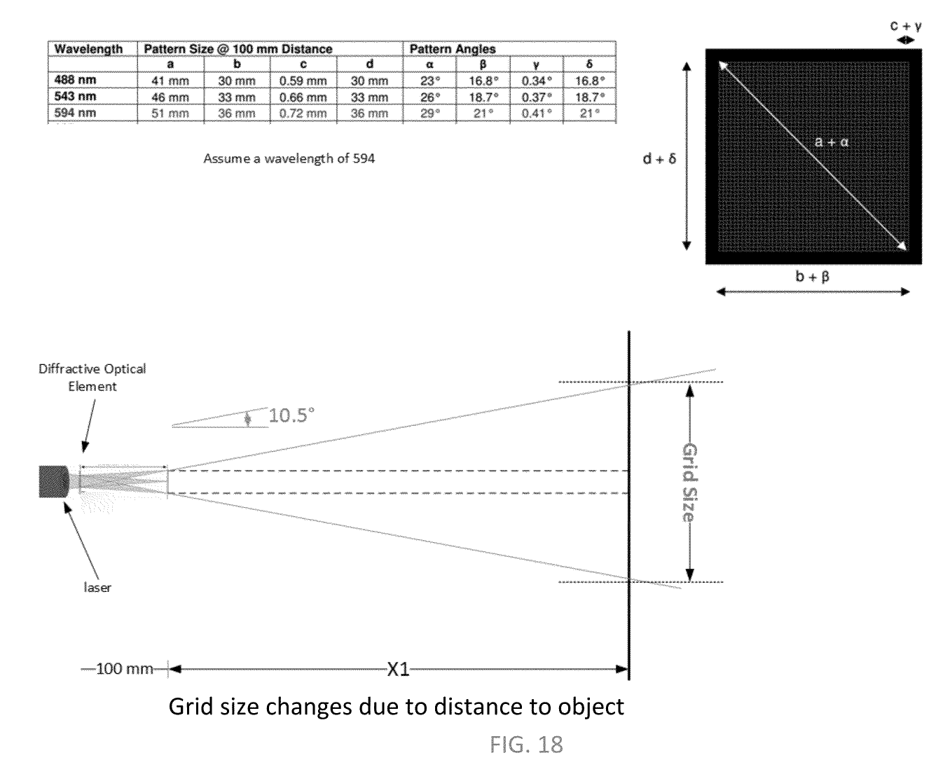

A grid or other geometric projection is projected onto the object. For simplicity of discussion, the term “grid pattern” will be used for discussion and demonstration. However, it is important to note that other types of geometric patterns can be used and a discussion of different types is presented below. FIG. 18 is an example grid pattern showing the relationship between the size of the grid and the distance between the project and the image plane. The angular divergence of the grid is a key parameter and varies between systems and as a function of wavelength.

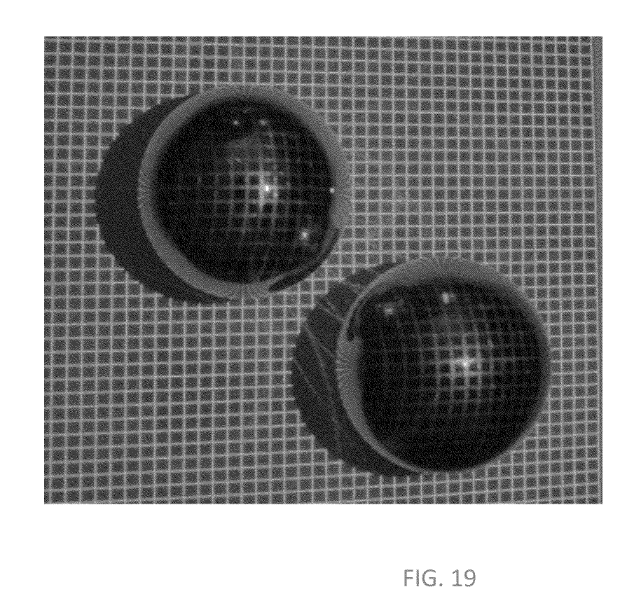

Each angle of the geometric pattern determines one degree of freedom of the local surface normal. Therefore, the total reconstruction of all visible surfaces is possible based upon the angular relationship of the grid pattern. The grid pattern is information rich since it contains line trajectory information and angular relationship information. FIG. 19 is an image of a round ball illuminated by a grid projection. The image illustrated the information content available via examination of line trajectories as well as intersection angles. The grid lines are straight and the grids are square when projected onto a flat surface. The projection of the grid onto the ball shows distortion due to the underlying surface of the object. The top of the ball is almost perpendicular to the optical axis of the system and the grid intersection is almost perpendicular. The side of the ball represents a sloped surface and the grid patterns is distorted and the grid intersection is not perpendicular.

The grid pattern is also sensitive to the distance between the projection element and the object or image plane. Reexamination of FIG. 18 shows this relationship with the table at the top of the figure defining the angular relationships. Specifically, the spacing between grid intersection points will be a function of the distance between the projector and the object or image plane. Stated simply, the grid becomes larger as the distance between the camera and the grid increases.

The area of the object that is directly illuminated by the grid pattern can be effectively determined based upon the distortion of the grid. The areas between the grid lines are not uniquely defined but both the hand and face represent smooth contoured objects so surface topology can be defined. Methods to reduce areas of ambiguity are discussed below.

Depth Map Creation via Fiducial Mark Calibration. In order to deduce the object's position and orientation from the image, the system must be calibrated so the relationship between the projected grid, the object and the camera are defined. For ease of illustration, a both a grid and a dot pattern will be used as the structured light pattern. However, a structured light pattern can be a grid or a dot pattern or any geometric pattern. The calibration images obtained at different z-axis locations enables the creation of a geometric model or relationship between the observed image and the prior calibration images. Historically, the calibration process for triangulation based system has been a complex process involving intrinsic and extrinsic correction. The parallel axis system uses a simple method for calibration. The calibration of a parallel axis system can be conducted with a flat surface, a ruler and the cellular phone.

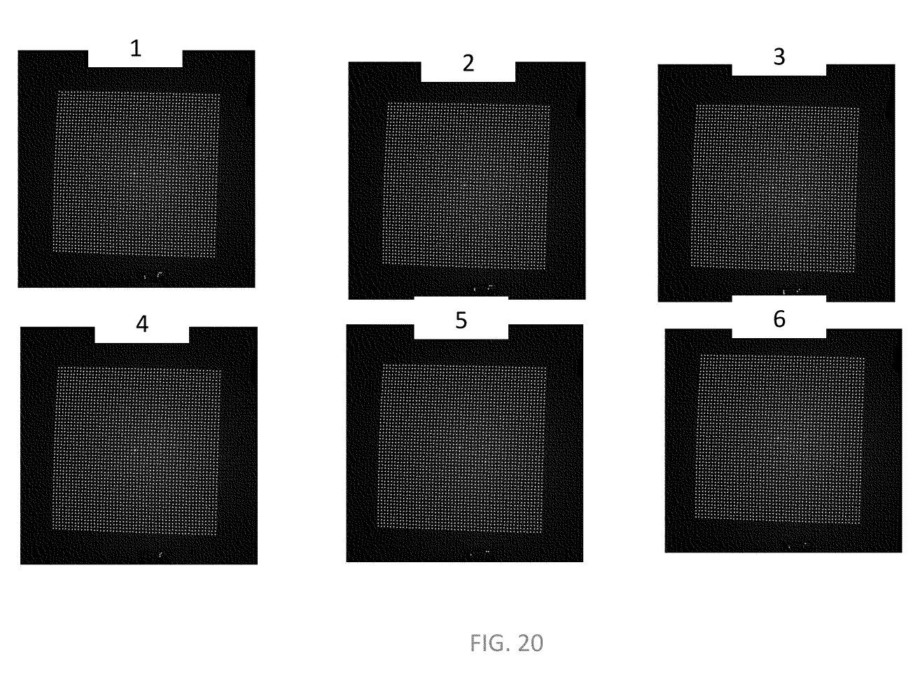

For illustration purposes, the calibration procedure used 7 images of a flat object with different distances between the flat object and the biometric system. In our example, a flat black panel was placed 1 meter from the camera and projector. The camera was a standard SLR Nikon camera and the dot matrix was generated by a diffractive optical element. This example used a dot pattern but a grid or other geometric pattern can also be suitable. The flat panel was positioned on a translation stage. Images were taken at positions of 0, 5, 10, 15, 20, 25, and 30 mm as the panel was moved toward the camera. FIG. 20 shows the resulting calibration images. These images hereafter are referred to as the calibration images.

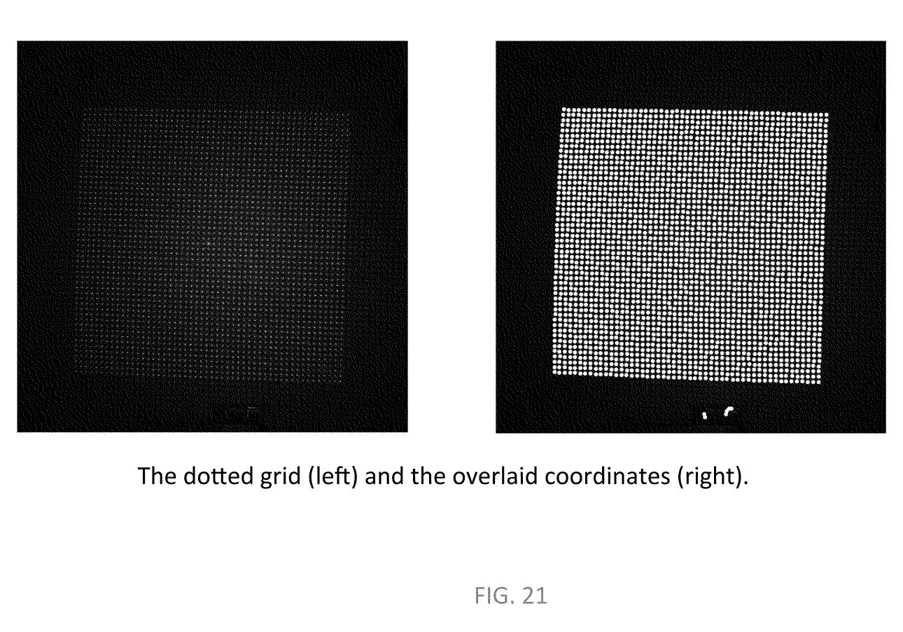

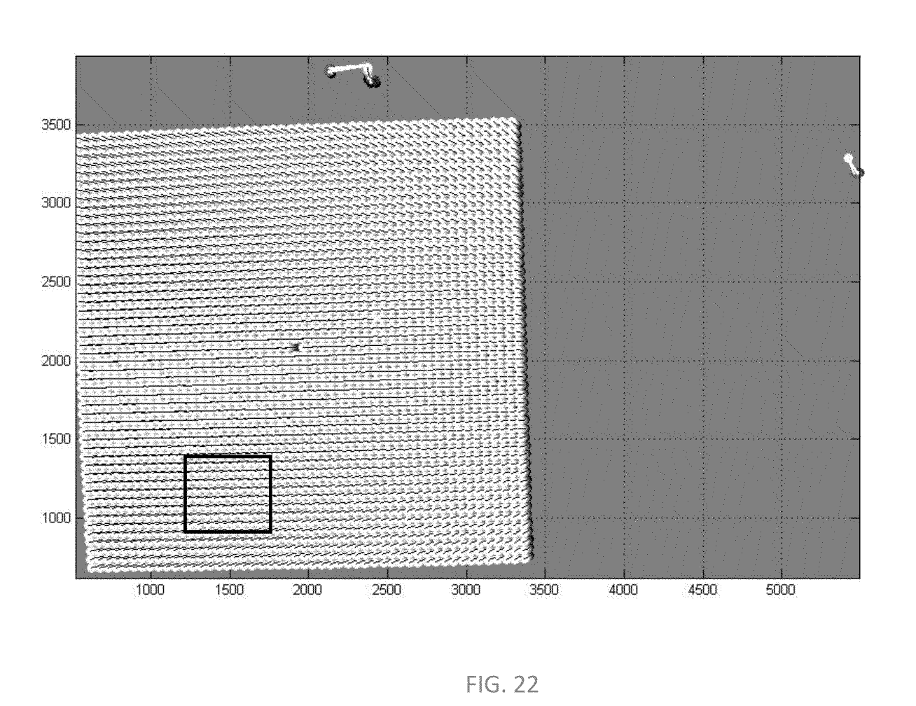

Following image acquisition, the coordinate points of the pattern were identified. FIG. 21[2] shows an example raw image and the coordinate or intersection points. Coordinate points and intersection points are interchangeable for the purposes of calibration. FIG. 22[3] shows all the intersection points from the calibration intersection images. For each intersection point (P_{i,j}) in a given image, a location of the intersection point can be defined (Xᵢ, Yⱼ). This process can be repeated for all intersection points and for all images. In the case described, the system has 7 calibration points. Thus, for each intersection point of the grid (P_{i,j}), the (Xᵢ, Yⱼ) location and the corresponding z-axis (Zₖ) location is defined.

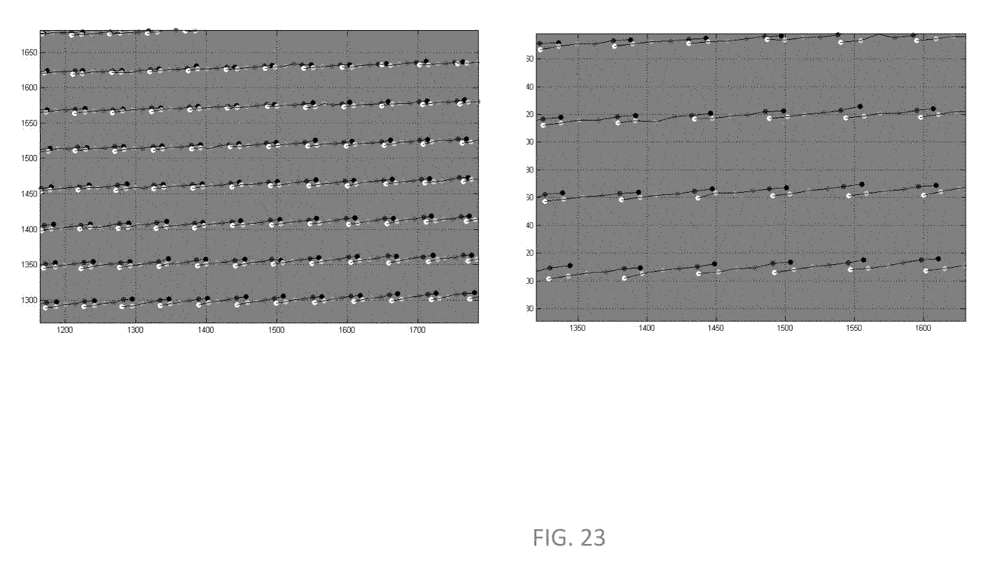

FIG. 23[4] is a magnification and a double magnification of the how these intersection point move as a function of Z-axis position changes in the panel. The intersection points move in response to a changing relationship between the biometric system and the flat object. These changes in location are a combination of magnification changes due to z-axis changes as well as location changes due to beam divergence of the projected pattern. Several important observations can be made for examination of figure. A 5 mm change in the z-axis imparts a large change on the location of the interception point enabling very accurate determination of the z-axis. Additionally the progression of the intersection points is very deterministic with a defined trajectory. The trajectory or angle of progression changes throughout the image but can be easily calculated.

The intersection points from the calibration images can then be used to define a calibration or mathematical model for each intersection point in the image. This calibration defines the relationship between the intersection location and z-axis. In an example embodiment, a simple least squares fit for each set of intersection points was used. The relationship between the change in location of the intersection points and the change in the z-axis is highly linear. This enables effective interpolation beyond the calibration points. shows an example of such information for a grid intersection point. The intersection point change location due to the z=axis location of the plane. The changes are well behaved and enable the development of a simple mathematical model. At the end of the calibration step, the following information for each intersection point is available: relationship between the change in location of the intersection point and corresponding z-axis change as well as the trajectory angle.

Referring now to an illustrative example is provided showing a perspective view of how a calibration images and an object image are utilized to determine the shape of the object surface. To determine the Z-axis location of an intersection point (P_{i,j}) on an object image the following steps can be utilized. Identification of grid intersection points. Note, not all of the object intersection points will identified due to shadows and other image artifacts. Once an object intersection point is identified a constrained search for the closest z=0 calibration point occurs. This search is along the trajectory defined in the calibration phase. The grid pattern projected onto the object may unpredictably shift, turn or twist due to change in the surface of the object. Thus, there is some complexity associated with such a search and minimization of errors is desired. In the illustration conducted, a search cone was utilized. The cone defines an acceptable angle of deviation as well as a maximum distance. The central axis of the search cone is defined by the trajectory of the calibration points.

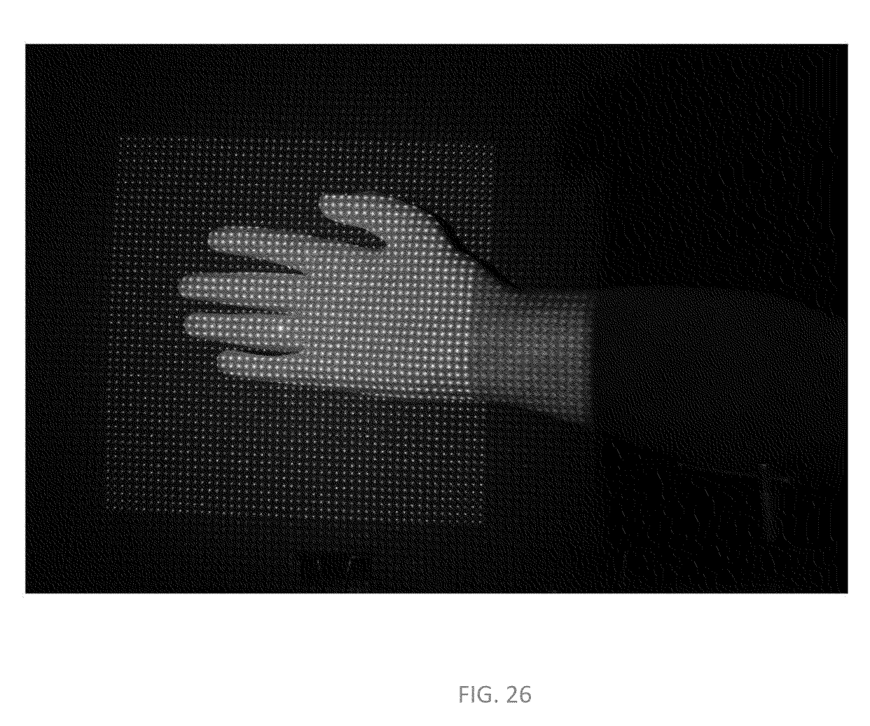

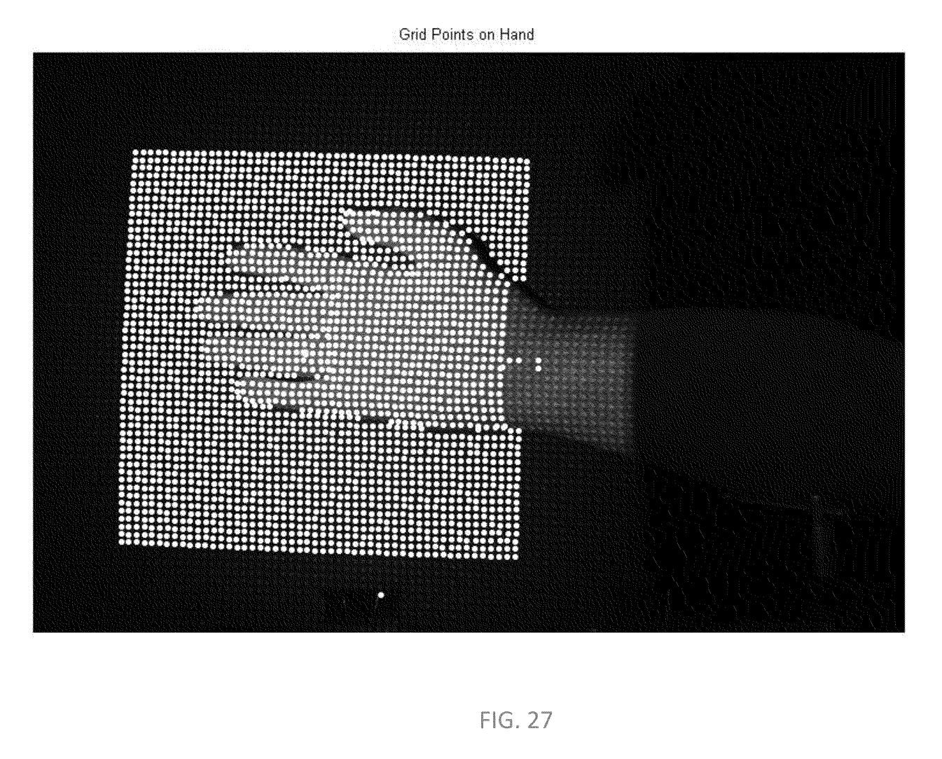

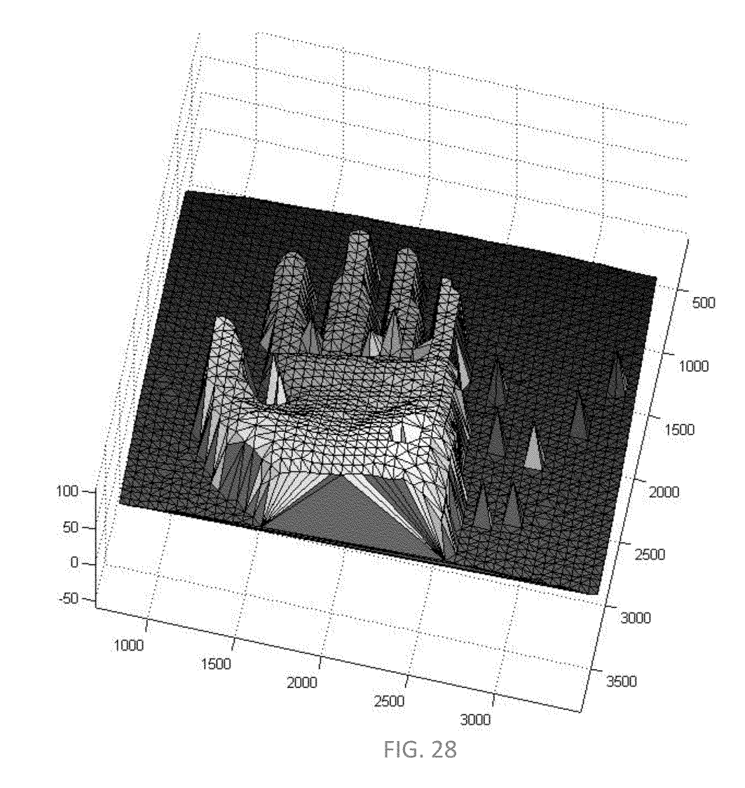

FIG. 26 is the raw image obtained by the camera. FIG. 27[5] shows the intersection or coordinate points from the prior image. FIG. 28 is the resulting depth mag created from the image. Examination of the image clearly shows significant detail and information regarding both the size and shape of the hand.

Depth Map via Grid Projection. This method utilizes the calibration images as previously described. The calibration images are obtained by projecting a grid onto a background plane, where the plane is a known distance from the camera. In each image the background plane is moved toward the camera by some distance; the grid reflects this change as it will vary in size as the plane approaches the camera. These images will be referred to as “calibration images.” An image of the object with an overlaying grid is then captured, referred to as the object image.

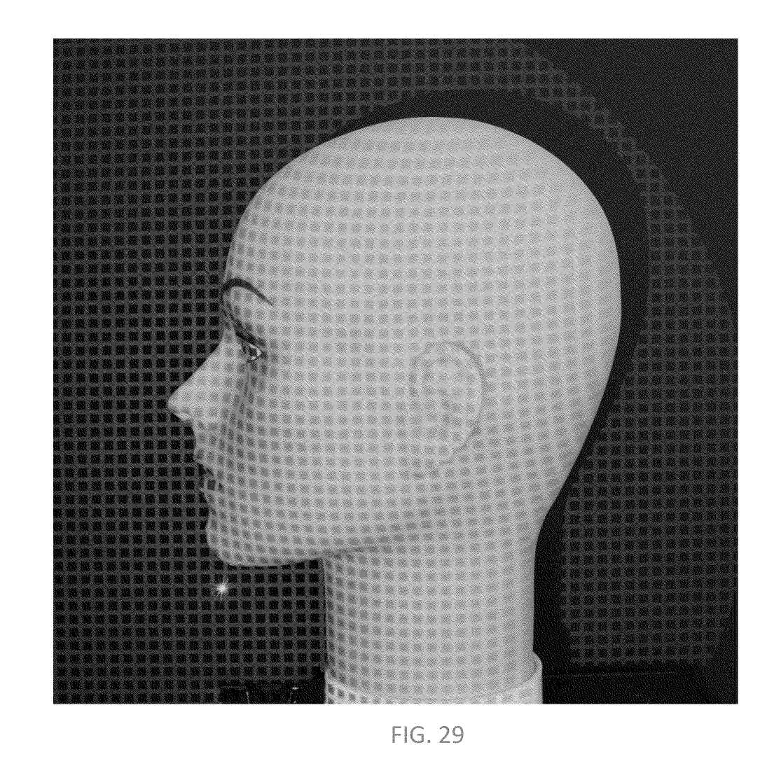

When a grid is projected onto an object, the depth of the object distorts the grid. Just as the size of the grid on the background plane varied based on the distance of the plane to the camera, the grid on the object will reflect its distance from the camera. The method will be demonstrated using the head image shown in FIG. 29. This distance to the object can be captured by noting that the grid on the object will locally resemble the calibration grid image which is the same distance to the camera. Because the changes in depth between the calibration images are known, the local depth of the object can be determined by finding the grid that best fits the grid shown on the object in a given region. The method works by generalized region and does not have the direct correspondence issues discussed in the prior intersection method.

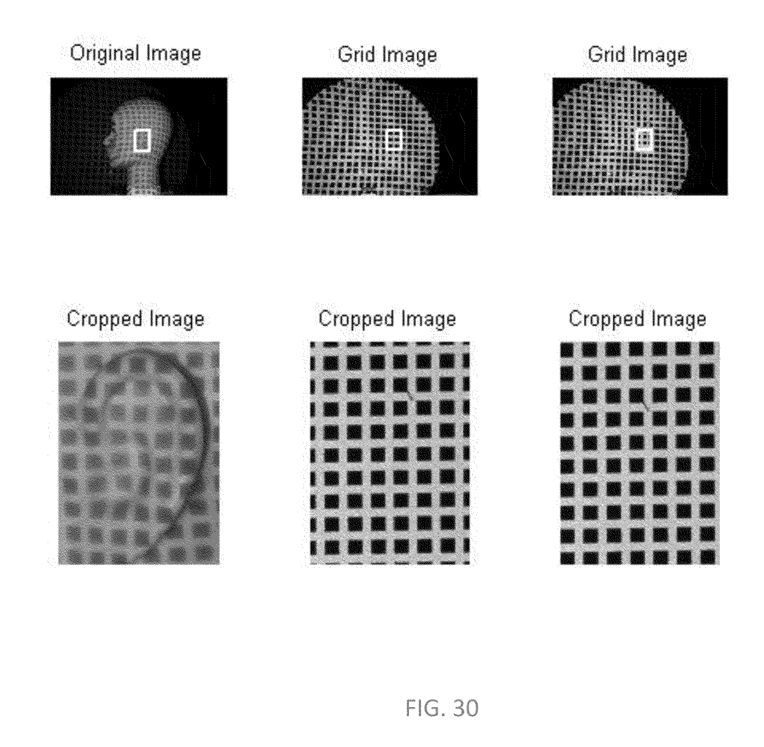

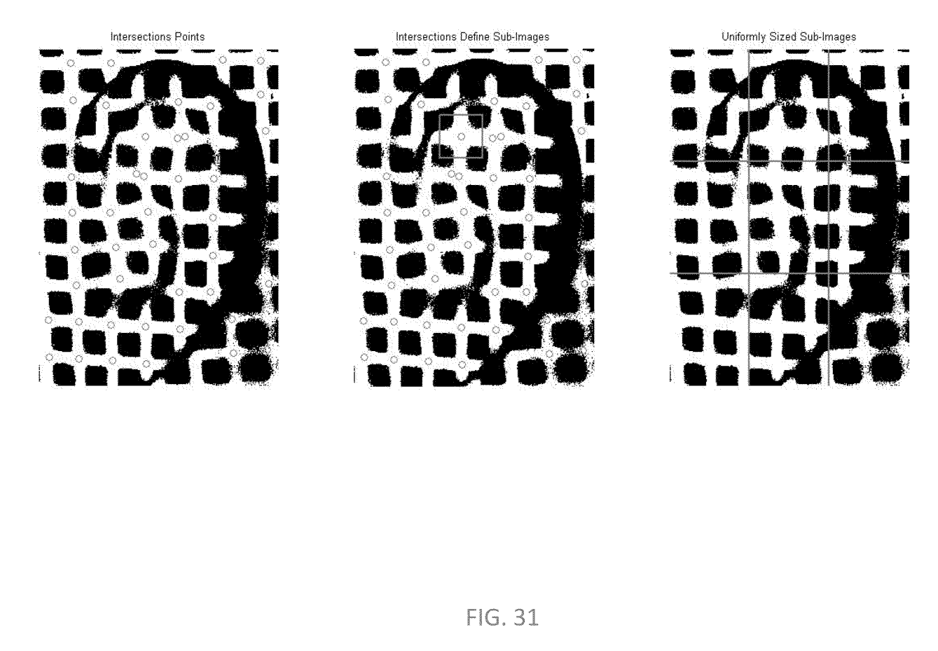

The method begins by cropping the object image into a set of sub-images, for example see the sub-images on FIG. 30. To ensure ideal placement of the sub-images, at least two methods can be suitable. One method is to find the intersections of the grids and use these points to determine the sub-images and the second method to divide the image into equally sized sub-images. These two methods can be seen in FIG. 31.

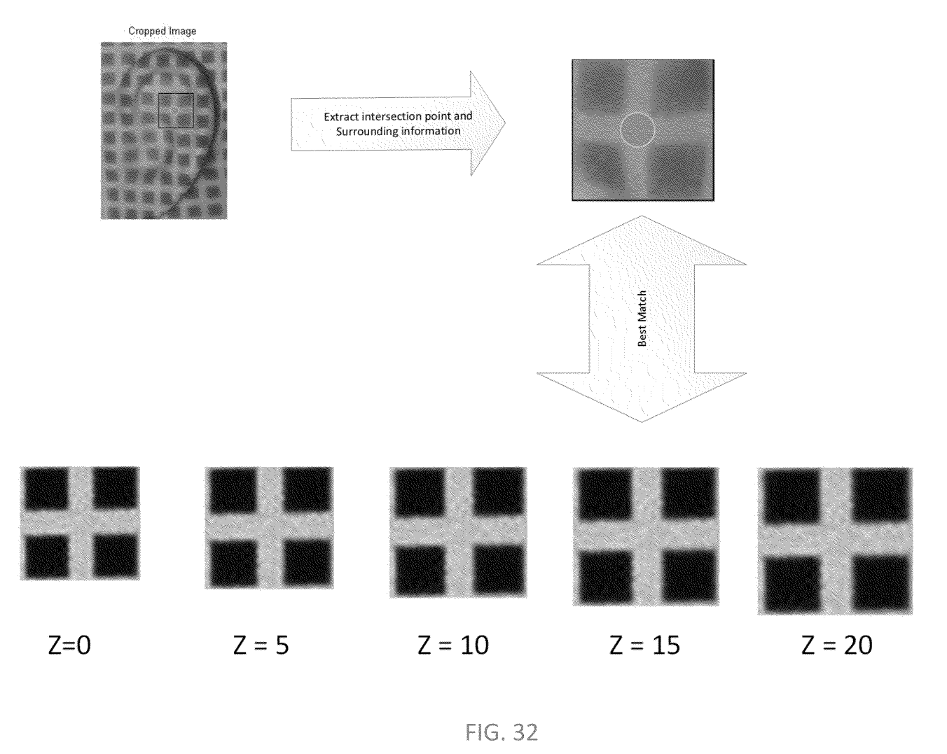

FIG. 32 is an illustrative example of how the intersection method is implement. An intersection as well as adjacent information is processed to determine the best match with a calibration grid image. The method can use the calibration images as well as interpolated images. Although not shown, images with different degrees of tilt can also be utilized. The resolution of the grid pattern influences the number of match areas within an image so additional grid lines can be added as needed.

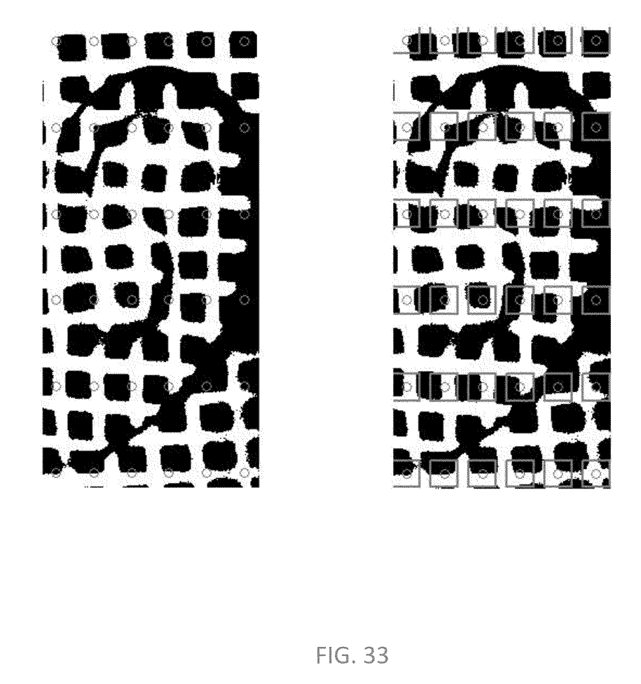

Another approach divides the image into equally sized sub-images. The size of each sub-image is standard and the location is determined by a mesh of points across the original image (FIG. 33). After obtaining the object image, a grid of points is placed onto the image (left). Each of these points becomes the center of a cropping region (right). Note that the cropping regions may overlap, so the size and number of regions may increase to create better resolution. Because these sub-images are permitted to overlap, the resolution of the depth map may be increased without being subjected to much additional noise. In this demonstration, the seven calibration images at 0, 5, 10, 15, 20, 25 and 30 mm were used. These images were cropped in the same way as the object image, as shown in FIG X. The next step is to determine which cropped calibration grid image has the best overlap with the given sub-image of the object image; that is, which sub-grid fits the particular portion of the object image best. The change in depth between grids is known, so the best fit grid will give the average depth of the object sub-image image. The image sub-size can be varies so that an accurate depth map is created. The depth map is created at each identifier point within the sub-region. X and Y correspond to the center of the sub-image and the z value is the depth change determined by the best fit grid. This process is repeated for each sub-image to create a 3D approximation of the object.

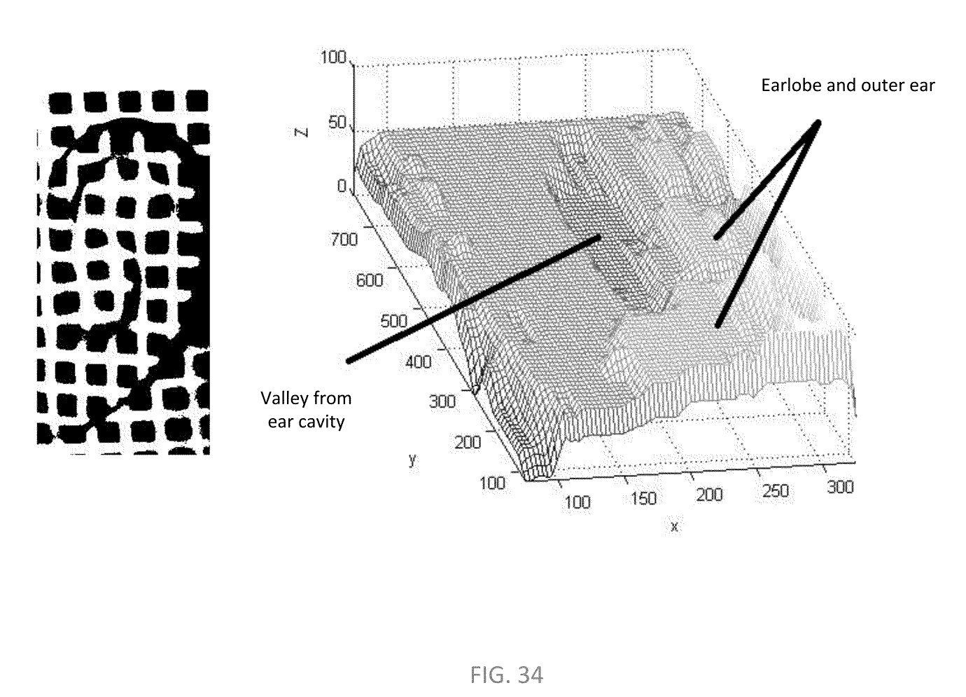

To demonstrate the utility of the method, it was used on an image of the ear on the prior head image. The object image and resulting depth map created by this algorithm are pictured in FIG. 34. The output of the method is shown on the right, a smoothing function has been applied for visual clarity. Each image is oriented in the same fashion, the upper left corners correspond. This particular implementation approach is limited by the number and distance between the background images. Here the distance between background grids is 5 millimeters, so the expected error on the depth map is up to ±5 millimeters. A more accurate depth map can be created by using a large set of calibration images; obtained either through capturing a larger number of images with the camera or using an interpolation from existing grids. Furthermore, this method can accommodate tilted object planes. To do so, if the planes containing the calibration images used for comparison can be tilted in the same fashion, an accurate depth map can still be created.

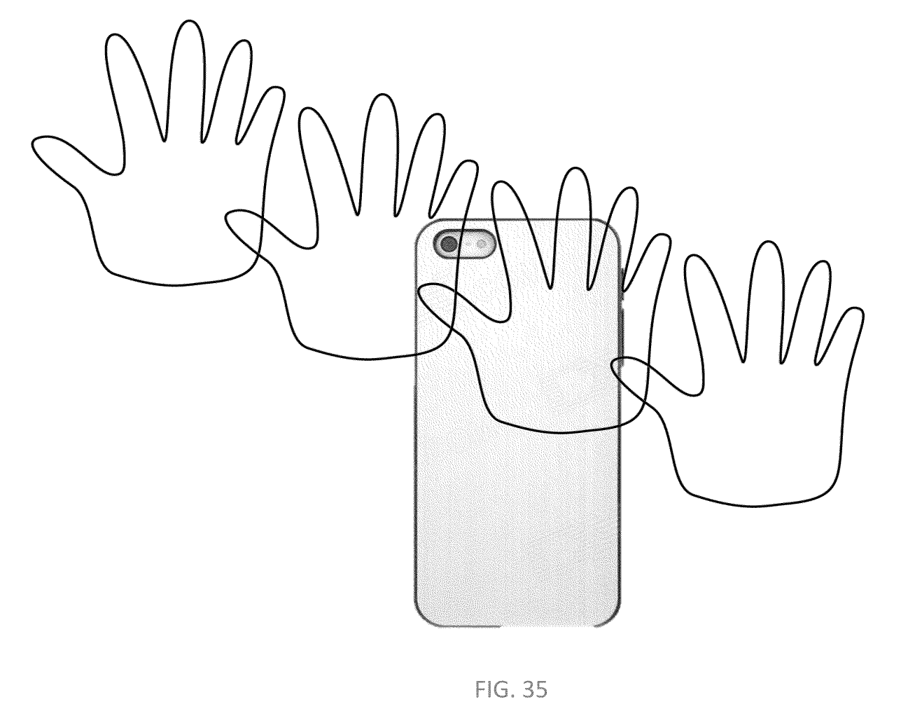

Increased Depth Map Fidelity. Depending upon the biometric application, the system can require a high fidelity and accurate depth map. As stated previously, the area illuminated by the grid pattern is uniquely located while area between grid line can be inferred based upon hand and face parameters but their exact locations cannot be determined. Examination of FIG. 26, showing an example of a hand moving through the field of view, shows the across most fingers there are approximately 4 grid intersections. If greater depth map resolution is desired several options are available. The frequency of grid lines can be increased. Additionally, the capability of a digital camera like those in current technology cellular phones can be leveraged to improve the resulting depth map information. FIG. 35 shows an example where the hand is moved across the field of view of the camera. For example, the iPhone 6 has the ability to take 120 frames per second in slow-motion mode. The ability to create multiple images as the hand moves across the grid pattern creates the information needed for a high resolution depth map.

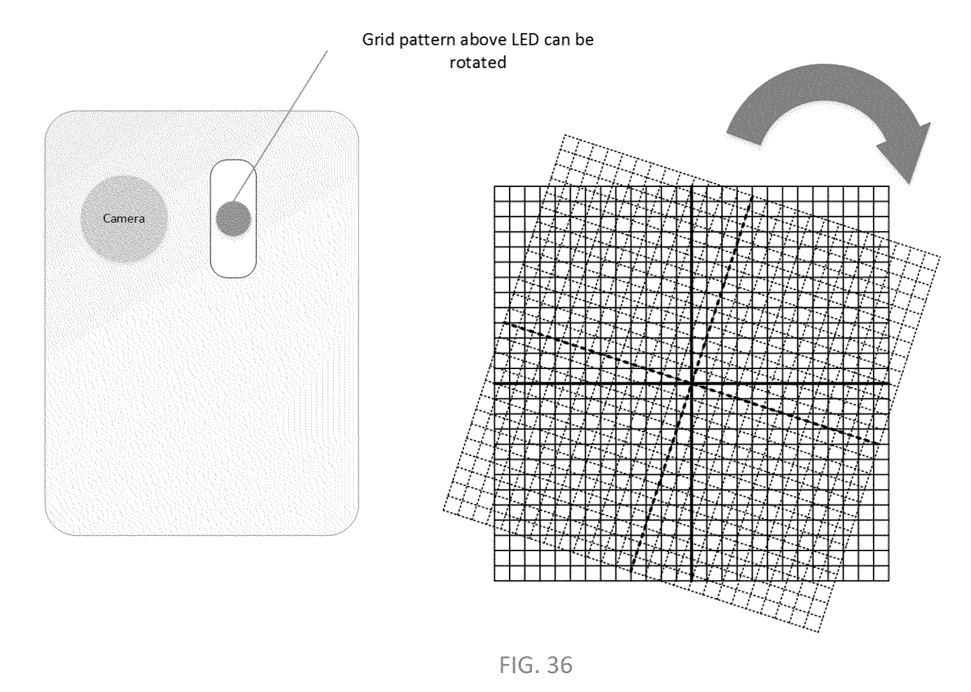

An additional option for creating increased resolution when the hand or face is stationary to rotate the grid. FIG. 36 shows a system for rotation of the grid pattern.

Additional resolution associated with the image can be obtained by superresolution. Supperresolution (SR) is a class of techniques that enhance the resolution of an imaging system. In some SR techniques—termed optical SR—the diffraction limit of systems is transcended, while in others—geometrical SR—the resolution of digital imaging sensors is enhanced. These methods can be utilized to improve overall image quality.

As discussed previously, the term grid pattern has been used in the broadest sense and simply relates to any geometrical pattern that can be projected. As noted previously, the correspondence issue associated with the calibration grid image and the object image can be address by encoding information into the grid projection.

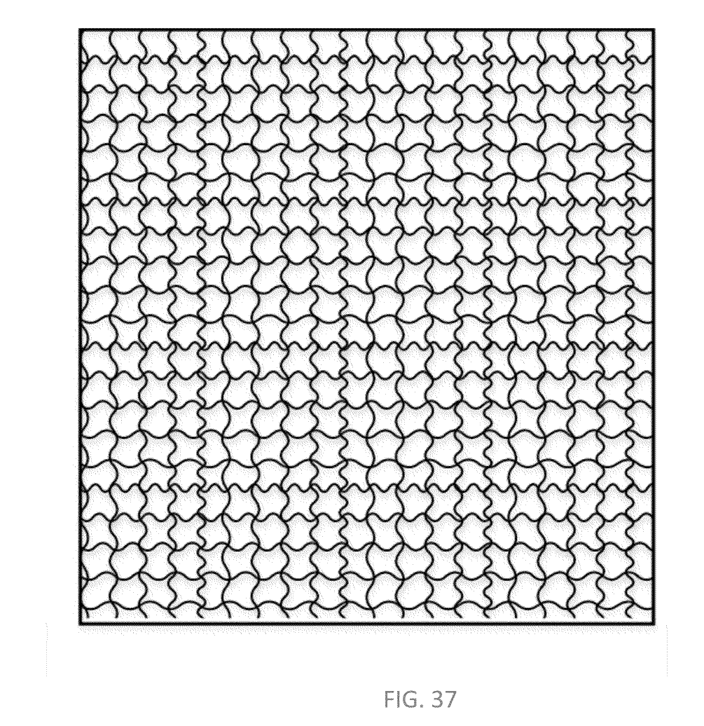

FIG. 37 shows a grid pattern composed of variable frequency sine waves that create the overall grid pattern. The result is a grid that contains correspondence information via the frequency or either the horizontal line of the vertical lines. The information contact of the pattern can be used enhanced by color coding the various lines. Additionally, the grid pattern can be composed of different wave forms such as square waves, triangle waves, etc.

The grid patterns used in some example embodiments used visible grid patterns but grid patterns outside of visible detection can also be used. Specifically infrared grids can be used and in fact can be preferable in some applications, e.g., if people do not appreciate having a green grid placed on their face.

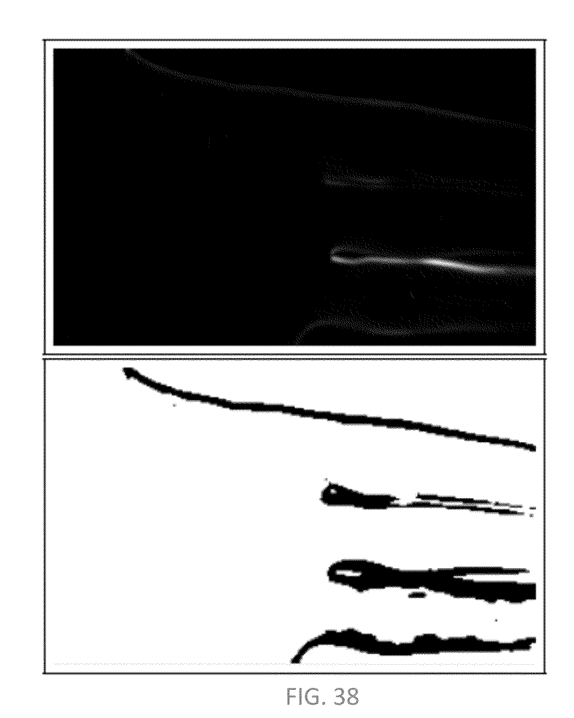

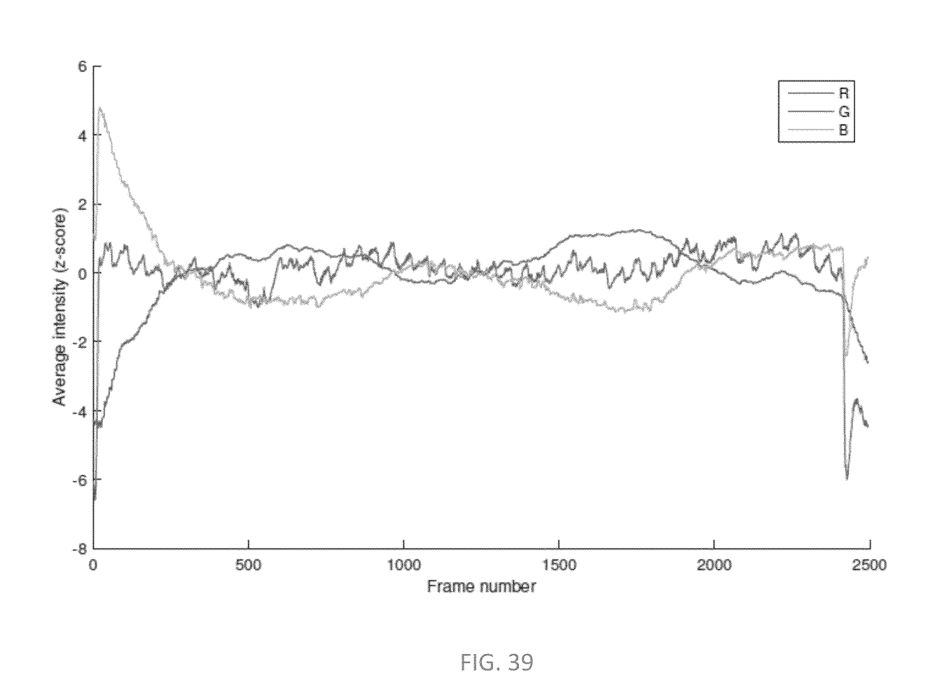

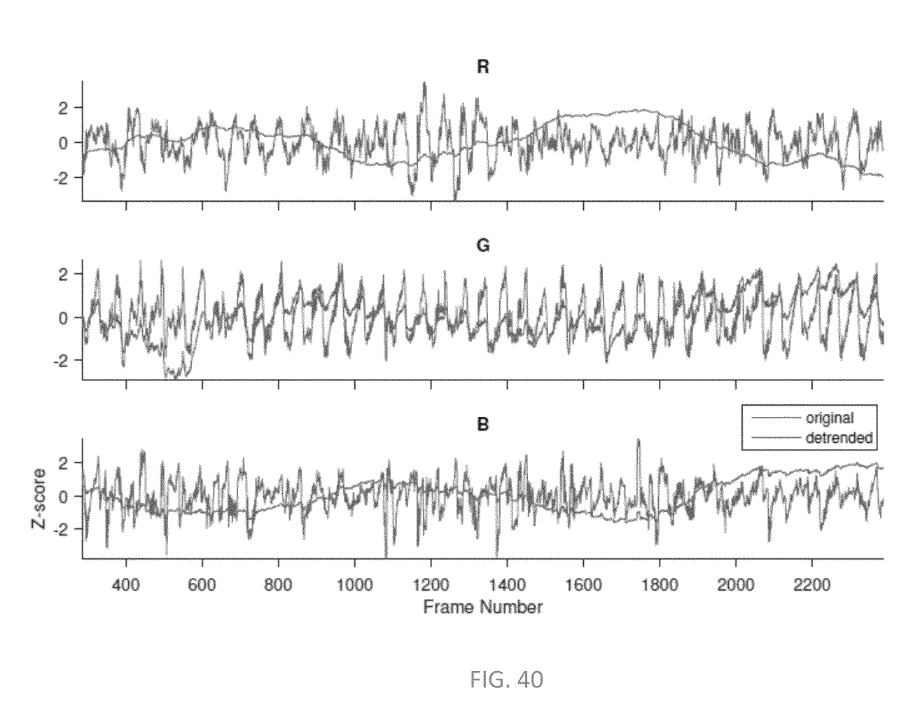

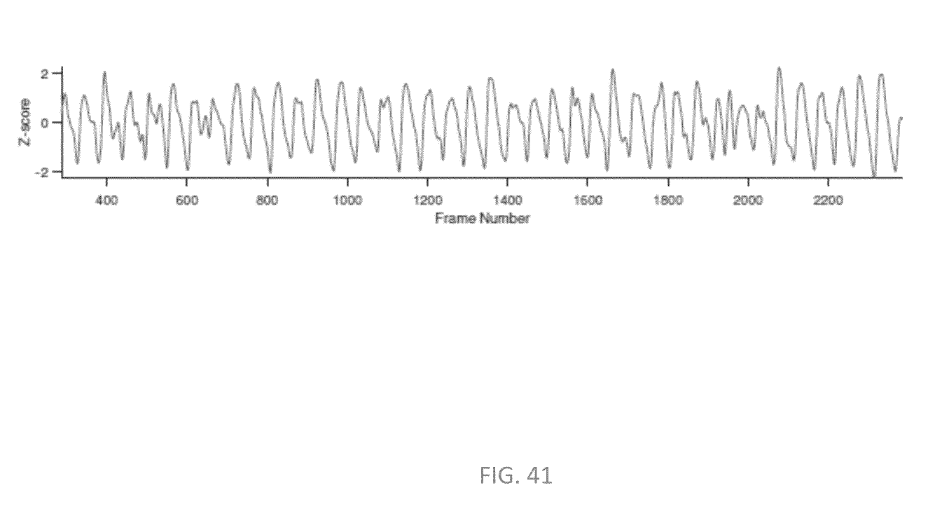

Spoof Detection. One possible problem associated with biometric detection using the present invention is the ability to use a hand model as the fake biometric. This problem can be minimized incorporating a non-contact photoplethysmogram. A photoplethysmogram (PPG) is an optically volumetric measurement of skin profusion. With each cardiac cycle the heart pumps blood to the periphery. Even though this pressure pulse is somewhat damped by the time it reaches the skin, it is enough to distend the arteries and arterioles in the subcutaneous tissue. The change in volume caused by the pressure pulse is detected by the optical system. The realtime calculation of a PPG from the hand during image acquisition can be used to ensure that a real hand is being used. An example of a suitable procedure follows the steps as proposed in McDuet al. (2014), “Remote Detection of Photoplethysmographic Systolic and Diastolic Peaks Using a Digital Camera”. The initial hand image was located using a simple masking function, FIG. 38. FIG. 39 shows the raw data as obtained for the red, green and blue channels. FIG. 40 shows the same single but signal processed to remove baseline changes. FIG. 41 shows the resulting pulse as observed by the hand.

The ability to detect pulse changes and to ensure that the hand or face is a real face can be further enhanced by the use of a thermal or infrared camera. In fact such a camera can be attached to a cellular phone and such a product is produced by FLIR System, Inc.

Utilization of Information. Historically, hand and palm biometric systems have used a flat platen for procurement of the hand or palm image. There are existing tools for extracting biometric features and existing biometric data bases. To create compatibility between historical systems and new systems it can be desirable to have intersystem compatibility or the ability to transfer templates. It can be desirable for the images acquired on the new light field system to be compatible with legacy systems. Therefore, it can be desirable to take a noncontact hand image and translate or normalize this image to a flat historical images.

The process of taking a curved or tilted hand and making it appear like the image was obtained by placement of the hand on a glass platen is similar to orthorectification. Orthorectification is the process of removing the effects of image perspective (tilt) and relief (terrain) effects for the purpose of creating a planimetrically correct image. The resultant orthorectified image has a constant scale wherein features are represented in their ‘true’ positions. This allows for the accurate direct measurement of distances, angles, and areas (i.e. mensuration). The “orthorectification” of the hand has additional complexity due the fact that the fingers might be curved.

The ability to remove tilt, yaw, and curvature can be accomplished by a combination of orthorectification techniques combined with skeletal linked model, skeletal animation and hand gesture methods. An orthophoto, orthophotograph or orthoimage is an aerial photograph geometrically corrected (“orthorectified”) such that the scale is uniform: the photo has the same lack of distortion as a map. In this case of a hand biometric, the goal is to “orthohand” the available information so the hand image has the same lack of distortion as an image acquired on a flat platen.

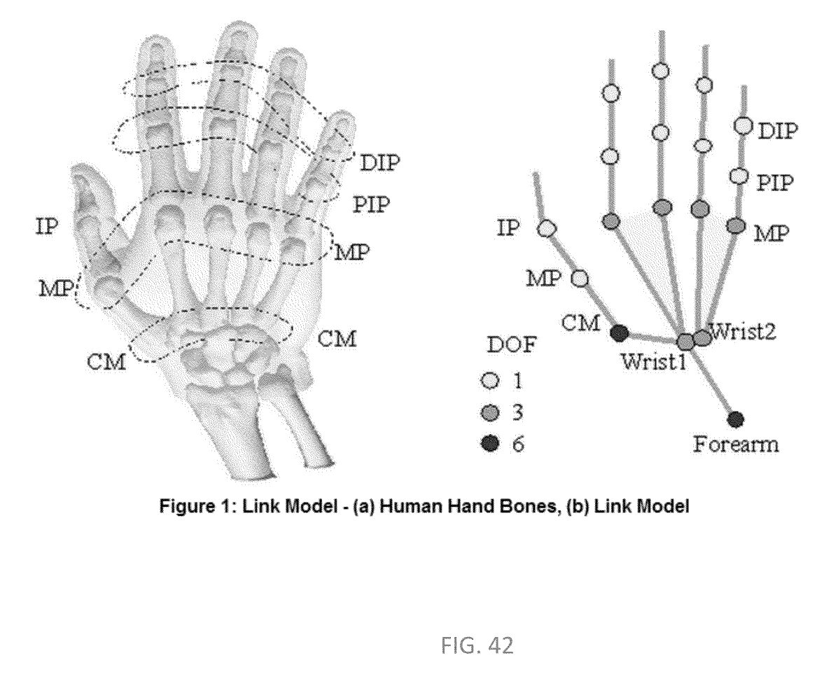

The hand in a simplified sense represents a series of linkages that are connected with joints having defined degrees of freedom and then covered by skin. In a very simple manner, the process of straightening the finger is as simple as placing the linkages so the angle between the linkages is 180 degrees. FIG. 42 shows an example of such a linked skeletal model. These fundamental principles are the basis for skeletal animation. Skeletal animation is a technique in computer animation in which a character is represented in two parts: a surface representation used to draw the character (called skin or mesh) and a hierarchical set of interconnected bones (called the skeleton or rig) used to animate the mesh. This type of method can become quite refined in terms of its capability to model human hand movement. For example, van Nierop, Onno A., Aadjan van der Helm, Kees J. Overbeeke, and Tom J P Djajadiningrat. “A natural human hand model.” The Visual Computer 24, no. 1 (2008): 31-44, present a skeletal linked model of the human hand that has natural motion. The model is achieved by introducing new biology-based joint axis that simulates natural joint motion and a set of constraints that reduce an estimated 150 possible motions to twelve. The model is based on observation and literature. In testing the authors used a simple low polygon count skin that can stretch and bulge.

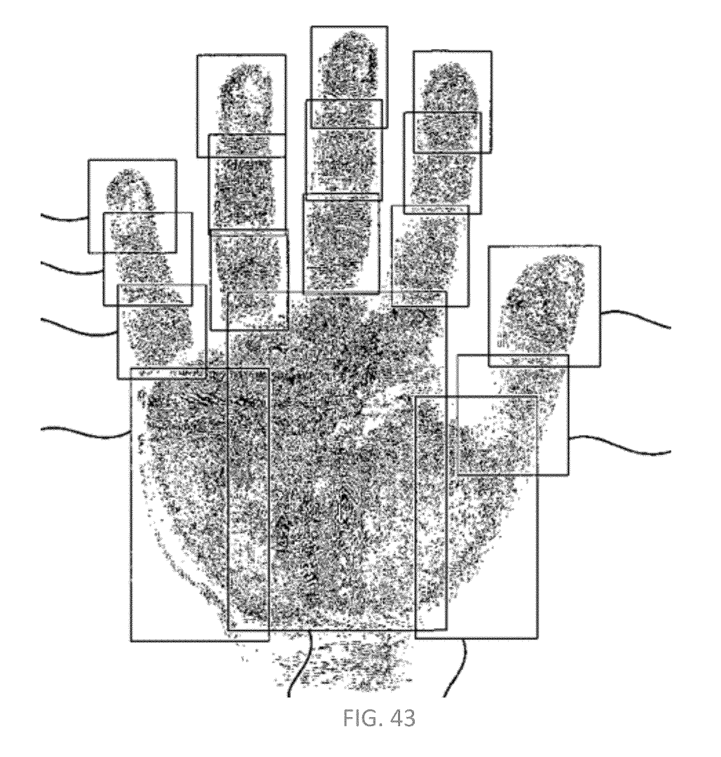

The 3D hand imprint can be used to estimate the joint locations as described by Rhee at al. This information can then be utilized to populate a skeletal linked model as described by van Nierop and others. The skeletal linked model can then be used straighten the fingers of the hand and to rotate the palm to a normal projection. The images of the skin can then be orthoreticified to the correct location and tilt on the hand. The process can require the orthoretification of many images over the hand surface. FIG. 43 shows an example of how multiple images can be combined or corrected to create a “flat” hand image that is comparable with those typically obtained for existing hand biometric systems. The process can be done in a continuous manner or via discrete image fields.

The net result of the “orthohand” methodology is to process light field image data taken for a unconstrained image and to translate both the hand and corresponding skin surface such that the resulting image is effectively the same as one obtained by placing the hand on a glass platen.

An alternative approach to create a flat had presentation is to use the 3D imprint model and determine the surface dimensions needed to cover the surface of the hand. Existing CAD projection tools can take 3D models and create 2D projections.

With respect to the skin, it represents a non-rigid material with elastic properties. Thus, the process of taking a curved hand and creating a valid “flat” model preferably can account for the stretch and deformation propertied of the skin.

The soft goods industry (teddy bears, steering wheel covers, cushions, etc.) utilize sophisticated tools for determining the cutting patterns based upon a 3D rendering. These tools can take something made out of fabric (imagine a stuffed teddy bear) and convert it into a flat pattern. These flat pattern pieces are the stitched together to create the three dimensional object. The tools have the ability to adjust for material stretching. The methods have the ability to account for the material properties of the fabric in question, including Poisson ratio and Young's modulus.

For a biometric application, these methods can require modification to compensate for the elastic properties of skin and the fact that skin is not symmetric. Additionally, the skin of the hand unlike that of the forearm has decreased motion relative to the supporting bone structure. The skin of the palm and finger is anchored down to the bones beneath through an intermediate layer of fascia. This arrangement keeps the skin of the palm from sliding around like a rubber glove when we use our hands to grip and twist. The characteristics of this attachment mechanism create differences relative to simple fabric covering situation and attachment point or points of limited movement may need to be incorporated.

The ability to use finger creases and palm creases to define seams or stitch points enables the creation of a template or pattern of flat pieces that is unique to each individual. Specifically, differences in the number of palm creases can alter the number of “seams” and provide additional biometric information.

Enrollment Process. The standard enrollment process of a hand geometry system typically requires the capture of three sequential images of the hand, which are evaluated and measured to create a template of the user's characteristics. Upon the submission of a claim, the system recalls the template associated with that identity; the claimant places his/her hand on the plate; and the system captures an image and creates a verification template to compare to the template developed upon enrollment. A similarity score is produced and, based on the threshold of the system, the claim is either accepted or rejected.

The enrollment process for a non-contact system according to the present invention can use the same three image process or a more complete training set. For example, the enrollment process can involve multiple images acquired at different degrees of tilt, or rotation. Additionally, the enrollment can require the hand to move from a fist to an open palm, tilt the palm, touch the thumb to the small finger, extend fingers individually, etc. Additional motion or hand movement activities can also be used. The use of a flat surface to ensure the hand is flat relative to the optical system can also be of use to ensure image capture of a hand image most consistent with existing biometrics.

Most of the biometric systems described previously have the ability to capture images in rapid succession or in video format. Thus the enrollment can consist of a series of hand motions in front of the optical system where all of the images are used in the enrollment process. This process will create a much larger data set for use in the enrollment process.

The ability to capture hand motions such as bending of fingers, etc., creates a significant set of data images. The use of multiple images can then be used to refine and improve the hand models used for biometric feature extraction. Due to age, injury or other issues an individual can exhibit alterations in their hand motion that require customization of the processing methods.

Such a training process can be especially useful when looking to create a set of hand normalized images. If the enrollment process contained a flat platen image, the error between the real flat image and the “orthohand” images acquired under different conditions can be minimized. The model parameters related to skin stretch, joint movement, etc. can be adjusted so as to maximize the ability to take an unconstrained hand image and create an “orthohand” image that best represents the hand image obtained by standard methods.

Direct Imprint Matching and Updating. Historically biometrics have compressed the measurements of the system into a set of salient features that best represent the identifying elements of the system. This compression has been required to address data transfer, storage and processing limitations. However, these limitations change on a daily basis with enhanced capabilities in all areas.

The ability to create a library of 3D imprints and all in focus images allows the development of direct match capabilities. The use of distance metrics between the hand/face to be identified and the library information can be used for identification purposes.

Improved performance can be possible by identifying several hand matches. If the identified matches are from the same individual, there would be improved confidence in the resulting identification.

Additionally, the library can be updated and expanded with new information as the individual uses the system.

Distributed Processing or Web Based Biometric. The process described above can be computationally expensive, and thus a distributed processing or remote processing method can be of benefit. The image content can acquired on an internet enabled device. Image information, location and time can be transmitted to a remote processing center for feature extraction. Authentication, identification or authorization can then be determined based upon the methods above.

In one example scenario, the standard camera on a laptop computer is modified to conduct focus stacking or to do compressive light field photography, or a sensor such as a Pelican Imaging sensor is placed in an external device. Regardless of the implementation, the laptop is able to acquire images with various depths of field and create an all in focus image. Web-based biometrics can provide a simple, state of the art solution that employ the existing web-based technology to identity, verify and authenticate users.

The user interface can comprise a web-browser that everyone is familiar with and comes installed with almost every computer sold. If light field camera capabilities are installed on every client machine, all users will be ready to start capturing the biometric information and sending it to the server for matching. This makes it a virtually maintenance-free client-side application and an ideal application for authenticating users over the internet.

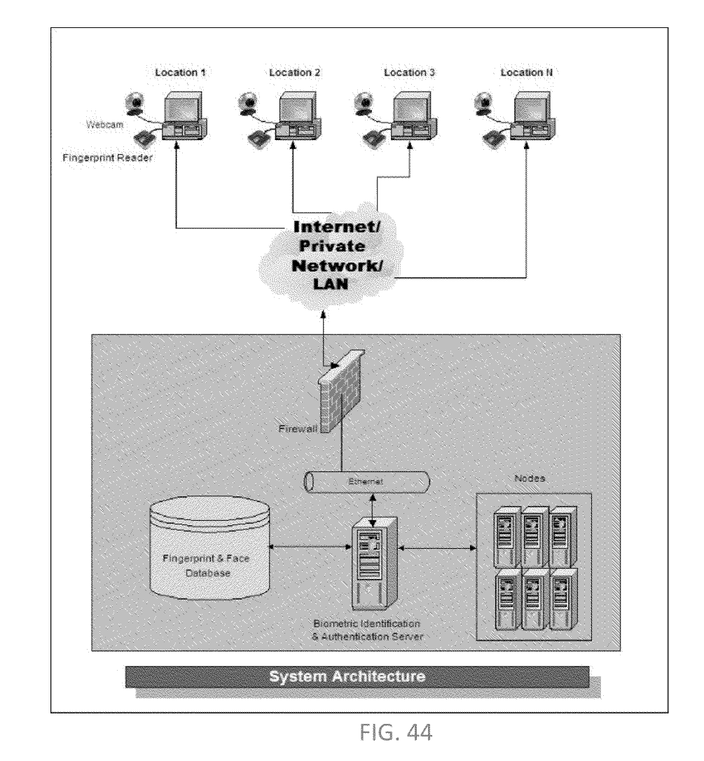

The system architecture of a web Biometric is shown in FIG. 44. The benefits of a web based system include: reduces IT management costs, simplifies deployment to clients, reduces license costs while effectively increasing license utilizations, eliminates weak passwords as a vulnerability, password lifecycle management is centralized, improves security of an organization and simplifies provisioning. Additionally, the centralization of processing creates a robust audit trail and creates a billing mechanism. Furthermore, key algorithms are maintained behind a firewall and algorithm updates are simple and do not require updating software on remote devices.

FIG. 1 shows an illustration of the biometric as incorporated onto a cellular phone. The system can be factory calculated based upon the known characteristics of the cellular phone camera or can be calibrated by the individual user. The user can calibrate the system by taking a series of images of a flat surface at known distances. This process can be automated by software on the device, instructing the user to move the device as the software acquires the images. The calibration can use an object of known characteristics (e.g., size and shape) to further simplify the calibration process for the user—the user just moves the device to different locations relative to the known object (e.g., the box used for shipping the device); the system can acquire the images and determine the calibration based on the images and the known characteristics of the object. In an alternative embodiment, the camera resident in the cellular phone is a camera capable of capturing light field images. Both embodiments are operated in a similar manner.

In FIG. 1 an optical element is configured to be placed over an illumination element of the device (typically a LED). The optical element can be controlled manually, as shown in the figure. It can also be controlled by the device, such as if the optical element is within the case. It can also be controlled by software, such as with an optical element whose optical characteristics can be manipulated electrically. It can be left operative, such as with an optical element that affects light outside the visible; e.g., an infrared grid can be used in connection with normal visible light photos, and also be ready for biometric use. If the device has a camera facing the same direction as the display of the device, then the display can be used to produce the grid. The grid can then use all the flexibility of the device display, allowing complex grids and even variable grids based on operating needs.

The system as shown in FIG. 1 could be used for biometric determination through the following process. Assume that user is accessing a bank account that requires additional security. The application inform the user to turn the phone over and move the grid pattern into a location covering the LED. At this point the user would place there hand above the camera. The camera would automatically detect the hand and determine if a significant portion of the hand is present in the field of view. Upon such determination data acquisition would be initiated and the user might be provided an audio clue. The LED used to generate the grid pattern could then be placed in a on mode but for battery conservation the LED could be flashed at the sampling frequency of the camera. In the case of an iPhone 6, the acquisition could be done at 120 frames per second in the “slow-motion” mode. During acquisition, the phone microprocessor would examine the images to ensure that an appropriate representation of the hand is obtained. Then an adequate sample has been obtained, the system stops acquisition and a second audio signal could be generated. At this juncture, the phone would process the data to create a compressed representation of the data acquired. The compressed data package could then be sent to a remote location for determination of match with a preexisting template. If a biometric match occurs then the user is allowed access to their bank account.

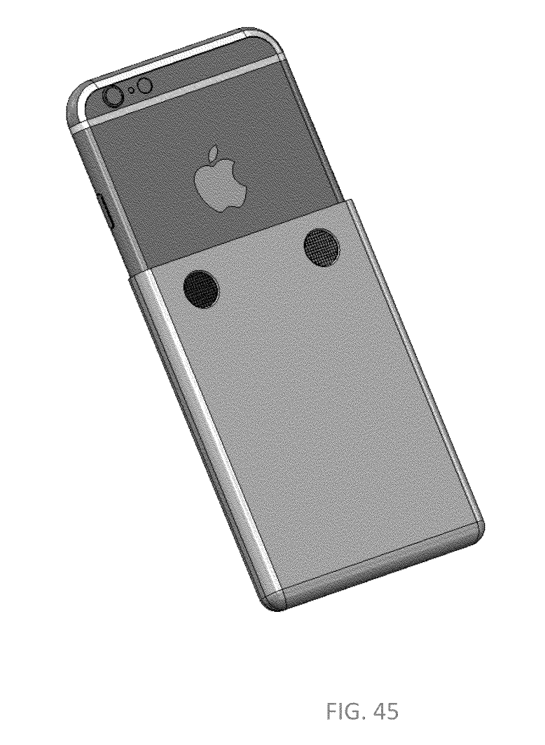

FIG. 45 is another example system that uses two grid patterns. These grids could be projected in the infrared, specifically at wavelengths longer than the eye can see. The use of two grids creates additional information that can be leveraged for improved depth determination.

A similar operation can be used for facial recognition for example at a door entrance. The biometric system can be located easily in the wall or other convenient location due to the small foot print of the system. The biometric can then procure a 3D representation of the face using one or more acquired images.

Both implementations can simultaneously acquire pulse information to facilitate anti-spoofing capabilities of the system.

The present invention has been described as set forth herein in relation to various example embodiments and design considerations. It will be understood that the above description is merely illustrative of the applications of the principles of the present invention, the scope of which is to be determined by the claims viewed in light of the specification. Other variants and modifications of the invention will be apparent to those of skill in the art.

We claim:

1. An apparatus for measuring an object in three dimensions, comprising:
(a) a projector, configured to project a structured light pattern onto a surface of the object;
(b) an image capture device, configured to accept light returned from the object responsive to the projector and generate an image of the object;
(c) wherein the optical axis of the projector and the optical axis of the image capture device do not intersect within the depth of field of the image capture device.

2. An apparatus as in claim 1, wherein the projector comprises a light source and a pattern generator that introduces a pattern into light produced by light source.

3. An apparatus as in claim 1, wherein the projector comprises a light source of a mobile phone, and wherein the image capture device comprises a camera of a mobile phone.

4. An apparatus as in claim 1, further comprising an analysis system configured to determine one or more characteristics of the object in three dimensions from the image captured and the characteristics of the structured light pattern.

5. An apparatus as in claim 4, wherein the object comprises an anatomical part of a human body, and wherein the analysis system determines a depth map from the image captured and the characteristics of the structured light pattern, and wherein the analysis system further determines biometric features of the human body from the depth map.

6. A noncontact biometric method based upon three dimensional measurements of an object, comprising:
(a) providing an apparatus as in claim 1;
(b) using the projector to project light having a structured light pattern onto a surface of the object;
(c) using the image capture device to produce an image of a surface of the object including the reflection of the structured light pattern from the surface;
(d) determining a measurement of the object from the image and from at least two calibration images, wherein each calibration image represents a geometric relationship between the image capture device and an object illuminated by the projector, and wherein the geometric relationship represented by one calibration image is distinct from that represented by at least one other calibration image.

7. A method as in claim 6, wherein the object is an anatomical part of a body, and wherein the analysis system is configured to determine whether the body is alive.

8. A method as in claim 7, wherein the determination of liveness is based upon a noncontact photoplethysmogram.

9. An apparatus for biometric determinations, said apparatus using three dimensional measurement of an object, comprising:
(a) a projector, configured to project a structured light pattern onto a surface of the object;
(b) a light field data acquisition device, configured to capture the full light field reflected from a surface of the object, including the reflection of the structured light pattern.

10. An apparatus as in claim 9, further comprising an analysis system, configured to determine one or more characteristics of the object in three dimensions from the light field captured and the characteristics of the structured light pattern.

11. An apparatus as in claim 9, wherein the object comprises an anatomical part of a human body, and wherein the analysis system determines a depth map from the light field captured and the characteristics of the structured light pattern, and wherein the analysis system further determines biometric features of the human body from the depth map.

12. An apparatus as in claim 4, further comprising;
a control system configured to use the projector and image capture device to capture multiple images of anatomical location of a human body;
and wherein the analysis system uses the image captured and the characteristics of the structured light pattern to extract biometric features; and uses said biometric features to perform biometric identification.

13. The apparatus of claim 12, where the anatomical location is the hand.

14. The apparatus of claim 12, where the anatomical location is the face.

15. The apparatus of claim 1, where the physical separation between the camera and the projector is less than 4 inches.

16. A method for noncontact biometrics comprising;
(a) using a light field data acquisition device to capture one or more light field images of the anatomical location;
(b) processing said light field images to extract biometric features;
(c) using said biometric features to perform biometric identification.
